(19) United States
(12) Patent Application Publication
(10) Pub. No.: US 2007/0228159 A1
(43) Pub. Date: Oct. 4, 2007

(54) Inquiry system, imaging device, inquiry device, information processing method, and program thereof

(76) Inventors: Kotaro Kashiwa, Kanagawa (JP); Mitsutoshi Shinkai, Kanagawa (JP)

Correspondence Address: William S. Frommer, Esq.;FROMMER LAWRENCE & HAUG LLP, 745 Fifth Avenue, New York, NY, 10151, US

(21) Appl. No.: 11/705,661

(22) Filed: Feb. 13, 2007

(30) Foreign Application Priority Data
Feb. 15, 2006 (JP) 2006-037939

(51) Int. Cl. G06K 5/00; G06K 9/00

(52) U.S. Cl. 235/380; 382/118

(57) ABSTRACT

An inquiry system which includes a portable imaging device and an inquiry device capable of communicating with the imaging device in two ways is provided. The imaging device includes an imaging unit, a communication unit, a face characteristic data generator extracting a face image from the image data picked up by the imaging unit and generating face characteristic data from the extracted face image, a transmission information generator generating inquiry information including the face characteristic data and transmitting the inquiry information to the inquiry device by using the communication unit, and a presentation processor performing a presentation process based on inquiry result information in response to reception of the inquiry result information transmitted from the inquiry device by using the communication unit. The inquiry device includes a communication unit, a face database, an inquiry processor, and a transmission information generator.

### CROSS REFERENCES TO RELATED APPLICATIONS

The present invention contains subject matter related to Japanese Patent Application JP 2006-037939 filed in the Japanese Patent Office on Feb. 15, 2006, the entire contents of which are incorporated herein by reference.

### BACKGROUND OF THE INVENTION

1. Field of the Invention

The present invention relates to an inquiry system configured to enable an imaging device and an inquiry device to communicate with each other, an imaging device, and an inquiry device. In addition, the present invention relates to an information processing method in an imaging device and an inquiry device and a program thereof.

2. Description of Related Art

Examples of the related art of the invention include JP-A-2003-274358, JP-A-2003-274359, JP-A-2003-274360, and JP-A-2002-314984.

In police organizations, security companies, private detective companies, and the like, to search for a person or to pay attention to a person is one of major duties. Examples are a search for a wanted person or a missing person and determination of a suspicious person.

### SUMMARY OF THE INVENTION

For example, when a case where a policeman or the like searches for a person in patrolling is considered, there were the following problems in the past.

Generally, the policeman or the like remembers a face to be searched using a face photograph of a missing person or a wanted person or takes a photograph with him in patrolling.

However, there is a capability difference in remembering a face person to person and there thus are many cases where the memory is not clear. In addition, there is a limit of the number of photographs to be taken with.

Moreover, since the patrol of the policeman is not only for searching for a specific person but also for regional security maintenance, it cannot be definitely determined that the policeman concentrates only on searching for a person in patrolling. In addition, even when the policeman takes photographs with him, he cannot pay attention only to the photographs.

In addition, since the appearance of a person may be changed considerably according to the length and style of hair, wearing glasses or a headgear, a policeman may not notice a person, for example, even when the policeman comes across the person in patrol.

In addition, even when the policeman comes across a person who is similar to a remembered face or a person in a holding photo, the determination of the identity is ambiguous, and accordingly there are many cases where the determination on whether a person is identical to a target person cannot be made instantly.

Here, as a technique for inquiring whether a person is a missing person or a wanted person, a method using a camera device can be considered. For example, a policeman or the like has a camera device during patrol. The camera device has a network communication function, so that it can communicate with a headquarter system of a police station or the like.

The policeman or the like picks up an image of a person in patrol using the camera device and transmits the picked-up image to the headquarter system. The headquarter system compares the transmitted image (face photo) to holding photos of missing persons or wanted persons or the like to determine the identity of the image to one of the persons corresponding to the holding photos and transmits the result of the determination to the policeman or the like.

Accordingly, since the determination of the identity doest not depend only on the personal memory or determination capability of the policeman in patrol, the accuracy of the determination of the identity can be improved.

However, there are the following problems in the above-described system.

At first, the transmission of the picked-up image to the headquarter system may be delayed considerably or only an image of a low image quality can be transmitted due to the data processing capability of the camera device having a communication function or the transmission capability or congestion of a used communication network. In addition, there are cases where an image should be picked up again and retransmitted since an image having a satisfactory quality cannot be transmitted.

In addition, since a staff in the headquarter system side should determine whether the transmitted image is identical to a target person by comparing the image to a photo or the like, it takes a time for the determination and the determination may not be always correct. The determination may be ambiguous due to change in the appearance or insufficient quality of the image like the onsite determination of a policeman as described above.

Moreover, it is not preferable that a time is spent for the transmission or the determination especially for a case where emergency may be required. For example, there is a problem in that a time is spent for determination of the identity of a wanted person who might flee.

In this viewpoint, an effective technique or system useful for searching for a person has not been realized. Thus, it is desirable to provide an effective system useful for searching for a person.

According to an embodiment of the present invention, there is provided an inquiry system useful for searching for a person.

The inquiry system according to an embodiment of the present invention includes a portable imaging device and an inquiry device capable of communicating with the imaging device in two ways.

The imaging device as a component of the inquiry system includes an imaging unit picking up image data, a communication unit communicating with the inquiry device, a face characteristic data generator extracting a face image from the image data picked up by the imaging unit and generating face characteristic data from the extracted face image, a transmission information generator generating inquiry information including the face characteristic data and transmitting the inquiry information to the inquiry device by using the communication unit, and a presentation processor performing a presentation process based on inquiry result information in response to reception of the inquiry result information transmitted from the inquiry device by using the communication unit.

In the imaging device, the face characteristic data may be relative position information of face components.

In the imaging device, the transmission information generator may generate the inquiry information including image identification information assigned to the image data from which the face image is extracted by the face characteristic data generator.

In the imaging device, the transmission information generator may generate the inquiry information including face identification information assigned to the face image that is extracted from the image data by the face characteristic data generator with the face identification information related with the face characteristic data.

In the imaging device, the imaging device may further include a position detector detecting position information, and the transmission information generator may generate the inquiry information including the position information as a location of picking up the image data which is detected by the position detector.

The imaging device may further include a personal information inputting unit inputting personal information, and the transmission information generator may generate registration information including the face characteristic data which is generated by the face characteristic data generator and the personal information which is input by the personal information inputting unit and transmit the generated registration information to the inquiry device by using the communication unit.

The imaging device may further include a recording and reproducing unit performing record and reproduction for a recording medium, and the recording and reproducing unit may record the image data from which the face image is extracted by the face characteristic data generator in the recording medium.

In this case, the recording and reproducing unit may record the image data from which the face image is extracted by the face characteristic data generating unit together with image identification information assigned to the image data in the recording medium.

In addition, the recording and reproducing unit may record the image data from which the face image is extracted by the face characteristic data generator together with face identification information related information that relates face identification information assigned to the face image included in the image data with a position of the face image in the image data in the recording medium.

In the imaging device, the presentation processor may perform a presentation process of personal information included in the inquiry result information.

In addition, the presentation processor may perform a presentation process of image data which is read from the recording medium by the recording and reproducing unit based on the image identification information included in the inquiry result information.

In addition, the presentation processing unit may perform a presentation process of the image data in a status that a target face image is indicated in the image data which is read from the recording medium by the recording and reproducing unit based on the face identification information and the face identification information related information which are included in the inquiry result information.

In addition, the presentation processing unit may perform a presentation process of position information included in the inquiry result information.

In the imaging device, the presentation processor may generate relative position information indicating a position represented by position information included in the inquiry result information from the current position information detected by the position detector and perform a presentation process of the relative position information.

In the imaging device, the communication unit may further include a reception notifying unit notifying that the communication unit has received the inquiry result information, and the reception notifying unit may select a notification mode based on registration type information included in the inquiry result information to notify the reception of the inquiry result information.

The inquiry device as a component of the inquiry system includes a communication unit communicating with the imaging device, a face database in which personal information is registered together with face characteristic data, an inquiry processor searching the face database using the face characteristic data included in the inquiry information in response to reception of the inquiry information transmitted from the imaging device by using the communication unit, and a transmission information generator generating the inquiry result information including the personal information found in the face database by the inquiry processor and transmitting the inquiry result information to the imaging device by using the communication unit.

In the inquiry device, the face characteristic data may be relative position information of face components.

In the inquiry device, the transmission information generator may generate the inquiry result information including image identification information included in the inquiry information.

In the inquiry device, the transmission information generator may generate the inquiry result information in which the personal information found by the inquiry processor is related with face identification information included in the received inquiry information.

The inquiry device may further include a map database in which map information is stored, and the transmission information generator may search the map database using position information included in the received inquiry information and generate position information as text data or image data based on the result of the search to generate the inquiry result information including the generated position information.

In the registration database, registration type information may be recorded together with the personal information and the face characteristic data, and the transmission information generator may generate the inquiry result information including the registration type information.

The inquiry device may further include a registration processor relating the face characteristic data and the personal information which are included in the registration information in response to the reception of the registration information including the face characteristic data and the personal information and registering the face characteristic data and the personal information in the face database.

As a method of processing information according to an embodiment of the invention, a method of processing information using the imaging device includes the steps of picking up image data, extracting a face image from image data which is picked up by the pick-up of image data and generating face characteristic data from the extracted face image, generating inquiry information including the face characteristic data and transmitting the inquiry information to the inquiry device, and performing a presentation process based on the inquiry result information in response to the reception of the inquiry result information transmitted from the inquiry device.

As a method of processing information according to another embodiment of the invention, a method of processing information using the inquiry device includes the steps of searching a face database in which personal information is registered together with face characteristic data using the face characteristic data included in the inquiry information in response to the reception of the inquiry information transmitted from the imaging device, and generating the inquiry result information including the personal information found in the face database by the searching the face database and transmitting the inquiry result information to the imaging device.

Programs according to embodiments of the invention are a program implementing the method of processing information using the imaging device and a program implementing the method of processing information using the inquiry device.

According to an embodiment of the invention described above, for example, a policeman or the like wears an imaging device in patrol. The imaging device picks up an image for example, at each predetermined interval. When a person's face is included in the picked-up image data, the imaging device generates face characteristic data from the face image and transmits inquiry information including the face characteristic data to an inquiry device.

When the inquiry device receives the inquiry information, the inquiry device searches a face characteristic database using the face characteristic data which is included in the inquiry information. Then, the inquiry device generates inquiry result information including personal information of a searched person and transmits the inquiry result information to the imaging device. Upon receiving the inquiry result information, the imaging device presents the contents of the inquiry result information, for example, personal information to a policeman or the like who has the imaging device.

In an operation of the system, the transmission data between the imaging device and the inquiry device does not include the image data itself. In other words, data size of the transmission data can be made much smaller than a case where image data is transmitted. In addition, since the inquiry device performs an automatic search based on the face characteristic data, the process of an inquiry can be performed quickly and correctly to be able to notify the imaging device side, that is, a policeman or the like of the inquiry result.

The face characteristic data used for processing an inquiry, for example, is information on the relative positions of the face components such as the eyes, nose and mouth, and the relative position is unique to a person and is not influenced by an attachment such as a hair style or glasses. In addition, it is known that the relative positions of the face components do not change with age.

According to an embodiment of the invention, even when the policeman or the like does not have a clear memory of a face of a target person, does not have a picture with him, has difficulty in determining a target person, or is unaware of searching for a person, the policeman or the like can acquire information on the searching target person. That is because the imaging device which the policeman or the like wears presents information based on the inquiry result information from the inquiry device. Accordingly, the policeman or the like who wears the imaging device can take a proper action based on appropriate information. For example, a policeman can take a proper action of protecting a missing person, arresting a wanted person, or the like as a reaction.

Moreover, although the imaging device transmits inquiry information of a small size including face characteristic data instead of the image data, by searching a face database based on the face characteristic data in the inquiry device, the presentation based on the inquiry result information can be performed in a very short time after the imaging, and thereby a speedy reaction for an onsite situation during patrol can be made.

In addition, by using the face characteristic data, the determination of the identity can be precisely performed. Of course, a problem in an image quality or a difficulty in determination does not occur unlike in a case where a face image itself is transmitted.

Owing to the advantage described above, an embodiment of the invention can be very useful for searching for a person or the like.

### BRIEF DESCRIPTION OF THE DRAWINGS

FIG. 1 is a schematic diagram showing an inquiry system according to an embodiment of the present invention.

FIG. 2 is a diagram showing an appearance of an imaging device according to an embodiment of the invention.

FIG. 3 is a diagram showing a method of using an imaging device according to an embodiment of the present invention.

FIG. 4 is a diagram showing a viewing angle of an imaging device according to an embodiment of the present invention.

FIG. 5 is a block diagram showing a configuration of an imaging device according to an embodiment of the present invention.

FIG. 6 is a block diagram showing a computer system implementing an inquiry device according to an embodiment of the present invention.

FIG. 7 is a block diagram showing a functional configuration of an inquiry device according to an embodiment of the present invention.

FIG. 8A is a table showing a structure of a face database according to an embodiment of the present invention.

FIG. 8B is a diagram showing relative positions of face components according to an embodiment of the present invention.

FIG. 9 is a flowchart of a registration process I according to an embodiment of the present invention.

FIG. 10 is a flowchart of a registration process II according to an embodiment of the present invention.

FIG. 11 is a flowchart of a transmission process of inquiry information of an imaging device according to an embodiment of the present invention.

FIGS. 12A, 12B, and 12C are images picked-up by an imaging device according to an embodiment of the present invention.

FIGS. 13A and 13B are diagrams for describing a face extraction process performed by an imaging device according to an embodiment of the present invention.

FIG. 14 is a diagram showing a structure of inquiry information according to an embodiment of the present invention.

FIG. 15 is a diagram showing an image file recording according to an embodiment of the present invention.

FIGS. 16A and 16B are diagrams for describing FID related information according to an embodiment of the present invention.

FIG. 17 is a flowchart of a processing an inquiry of an inquiry device according to an embodiment of the present invention.

FIGS. 18A and 18B are diagrams showing a structure of inquiry result information according to an embodiment of the present invention.

FIG. 19 is a flowchart of a reception process of inquiry result information of an imaging device according to an embodiment of the present invention.

FIGS. 20A and 20B are diagrams for describing display based on inquiry result information according to an embodiment of the present invention.

### DETAILED DESCRIPTION OF PREFERRED EMBODIMENTS

Hereinafter, embodiments of the present invention will be described as a following order.

1. Schematic Configuration of Inquiry System

2. Configuration of Imaging Device

3. Configuration of Inquiry Device

4. Registration Process of Face Database

5. Imaging Operation and Transmission of Inquiry Information of Imaging Device

6. Processing Inquiry of Inquiry Device

7. Process of Imaging Device When Inquiry Result Information is Received

8. Advantage of Embodiments and Modified Example

1. Schematic Configuration of Inquiring System

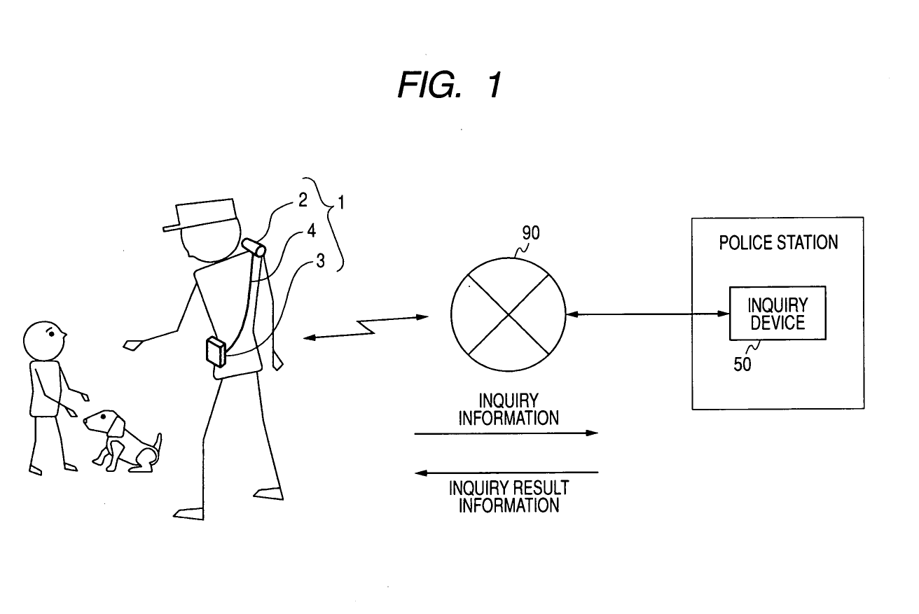

FIG. 1 is a schematic diagram showing an inquiry system according to an embodiment of the present invention. In the embodiment, an example of implementing the inquiry system, for example, appropriate for the use for security or police, more specifically, for searching for a missing person or a wanted person is shown.

The inquiry system, for example, includes an imaging device 1 which is worn by a policeman in patrol and an inquiry device 50 which is used in a headquarter of a police station.

The imaging device 1 includes a camera unit 2 and a control unit 3 which are configured as separate bodies. The camera unit 2 and the control unit 3 are connected to each other through a cable 4 for signal transmission therebetween.

The camera unit 2, as shown in the figure, is disposed on the shoulder of a user. The control unit 3 is in a form which can be disposed on the waist of the user, in a pocket of clothes, or the like, so that the user can pick up an image without using his hands while moving.

The imaging device 1 (control unit 3) can communicate with an inquiry device 50 through a network 90 in two ways.

As the network 90, a public network such as the Internet or a cellular phone network may be used. However, in case for the use for the police, a dedicated network may be configured.

Although an imaging device 1 which is worn by one policeman is shown In FIG. 1, but, for example, imaging devices 1 may worn by a plurality of policemen, respectively. In this case, each of the imaging devices 1 can communicate with the inquiry device 50 through the network 90.

The inquiry device 50 includes a face database, to be described later, which records persons required to be searched including missing persons and wanted persons. The inquiry device 50 processes an inquiry using the face database.

The operation of the inquiry system is as follows.

As shown in the figure, the policeman is wearing the imaging device 1 in patrol or the like. The imaging device 1 automatically picks up an image at each regular interval, for example, of one to several seconds. The imaging at each regular interval is to acquire an image for generating inquiry information. As an actual operation, one frame image at each predetermined interval may be input as a target while an image of a subject is detected continuously by an imaging element like capturing a motion picture.

When an image of a person's face is included in the input picked-up image data, the imaging device 1 generates face characteristic data from the face image and transmits inquiry information including the face characteristic data to the inquiry device 50.

When the inquiry device 50 receives inquiry information from the imaging device 1, the inquiry device 50 searches the face characteristic database using the face characteristic data which is included in the inquiry information. In the face database, personal information corresponding to the face characteristic data has been registered. When personal information for a specific person is found by searching the face database, the inquiry device 50 generates inquiry result information including the found personal information and transmits the inquiry result information to the imaging device 1.

Upon receiving the inquiry result information, the imaging device 1 provides the personal information and related information to the policeman who has the imaging device 1 as a content of the inquiry result. For example, the information is displayed to be noticed by the policeman.

For example, as shown in FIG. 1, it is assumed that the policeman meets a child in patrol. In this case, an image of the face of the child is picked up by the imaging device 1 and inquiry information including face characteristic data is transmitted to the inquiry device 50.

When the child is registered as a missing person, the inquiry device 50 transmits the inquiry result information including the personal information to the imaging device 1. Then, the imaging device 1 displays information based on the inquiry result information. Accordingly, the policeman can know that the child is a target to be searched as a missing person, so that the policeman can take an appropriate action such as protecting the child or contacting his parents or the like.

2. Configuration of Imaging Device

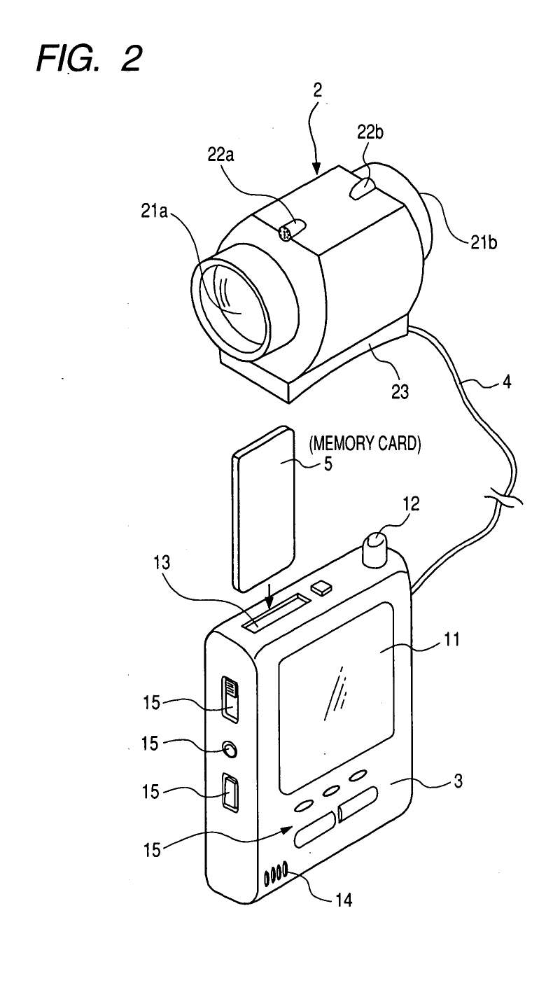

FIG. 2 is a diagram showing an exemplary appearance of an imaging device 1 according to an embodiment of the invention.

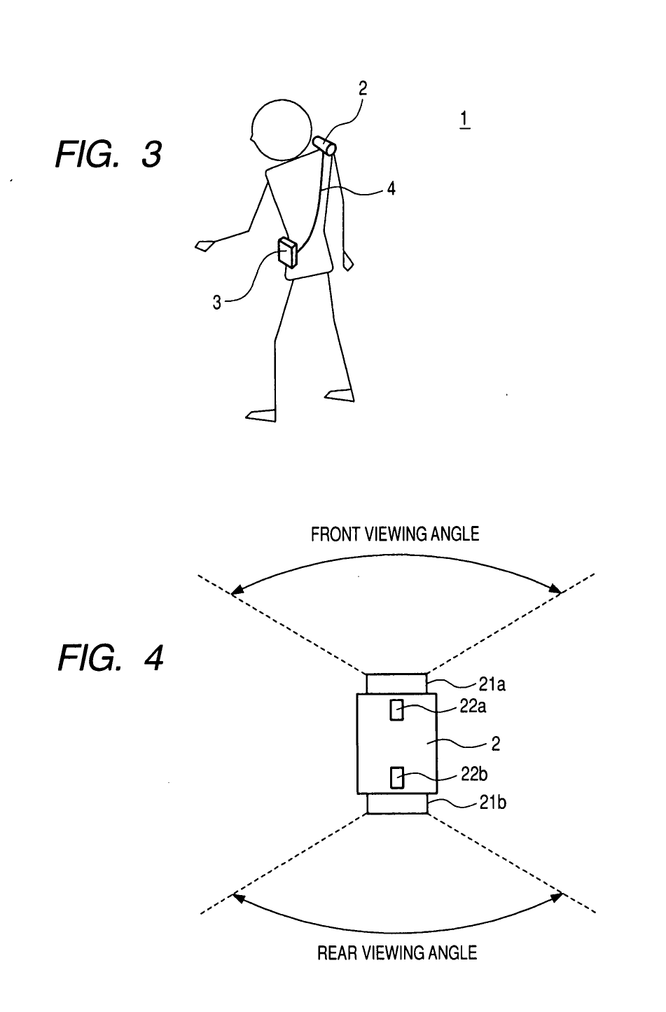

As described above, the imaging device 1 has a configuration in which a camera unit 2 and a control unit 3 are connected to each other through a cable 4 for signal transmission therebetween. The camera unit 2, for example, as shown in FIG. 3, is worn by a user on the shoulder, and the control unit 3 is attached to the wrist of a user or placed in a pocket of clothes.

Various techniques may be used for wearing the camera unit 2 on the shoulder. Although the techniques are not described here in detail, a member which maintains a base section 23 of the camera unit 2 may be formed on clothes (security jacket or the like) of a user or a wearing belt or the like may be used, so that the camera unit 2 can be worn on the shoulder.

The camera unit 2 may be attached to the top portion or a side face of a user's helmet or worn on the chest or the arm, but since the shoulder is a portion which has a little shaking even when the user walks, the shoulder is the best place for wearing the camera unit 2 which picks up an image.

As shown in FIG. 2, the camera unit 2 includes two camera sections of a front camera section 21a and a rear camera section 21b. In addition, the camera unit 2 includes a front microphone 22a and a rear microphone 22b corresponding to the front and rear camera sections 21a and 21b, respectively.

In the wearing status shown in FIG. 3, the front camera section 21a picks up a front side image of the user, and the rear camera section 21b picks up a rear side image of the user.

Since the front camera section 21a and the rear camera section 21b include wide-angle optical lenses, respectively, the viewing angles for picking up images are, as shown in FIG. 4, relatively wide angles. By adjusting the front camera section 21a and the rear camera section 21b, the camera unit can pick up an image almost all around the user.

In the wearing status shown in FIG. 3, the front microphone 22a has a high directivity in the front direction of the user and collects sound corresponding to a scene which is picked up by the front camera section 21a.

In the wearing status shown in FIG. 3, the rear microphone 22b has a high directivity in the rear direction of the user and collects sound corresponding to a scene which is picked up by the rear camera section 21b.

The front viewing angle and the rear viewing angle as respective ranges for picking up an image of the front camera section 21a and the rear camera section 21b may be designed to have various numbers based on the design of a lens system used and the like. The viewing angle is to be set based on a situation in which the imaging device 1 is used. Of course, the front viewing angle and the rear viewing angle do not need to be the same, and the viewing angle may be designed to be narrow for some types of the camera unit.

Similarly, the directivity of a front microphone 22a and a rear microphone 22b may be designed variously according to the use. For example, a configuration in which one non-directivity microphone is disposed may be used.

The control unit 3 includes a recording function of storing a video signal (and an audio signal) of which image is picked up by the camera unit 2 in a memory card 5, a communication function of performing data communication with the inquiry device 50, a user interface function such as a display operation, and the like.

For example, in a front side of the control unit 3, a display section 11 including a liquid crystal panel or the like is formed.

In addition, a communication antenna 12 is formed in a proper position.

In addition, a card slot 13 in which the memory card 5 is inserted is formed.

In addition, a voice output section (speaker) 14 which outputs an electronic sound or a voice is formed.

Although not shown, a headphone connecting terminal and a cable connecting terminal which is used for data transmission from/to an information device according to a predetermined transmission standard, for example, USB or IEEE1394 may be provided.

As an operation section 15 which is used for the user's operation, various keys, slide switches, or the like are included. Of course, an operating part such as a jog dial or a trackball may be used.

The operation section 15, for example, may have a configuration in which various operation inputs, for example, for a cursor key, an enter key, or a cancel key can be made by operating a cursor on a display screen of the display section 11 for enabling the user to input various operation. Alternatively, the operation section 15 may have a configuration in which dedicated keys for imaging start, imaging stop, mode setting, power on/off, and other basic operations are provided.

For example, as shown in FIG. 3, by a user's wearing the imaging device 1 according to the example which is formed by the camera unit 2 and the control unit 3, as described above, almost unrecognized hands-free imaging can be made. Accordingly, when a security guard or a policeman picks up a surrounding scene, while performing other operations, or picks up an image in patrol, this type of wearing the imaging device is preferable.

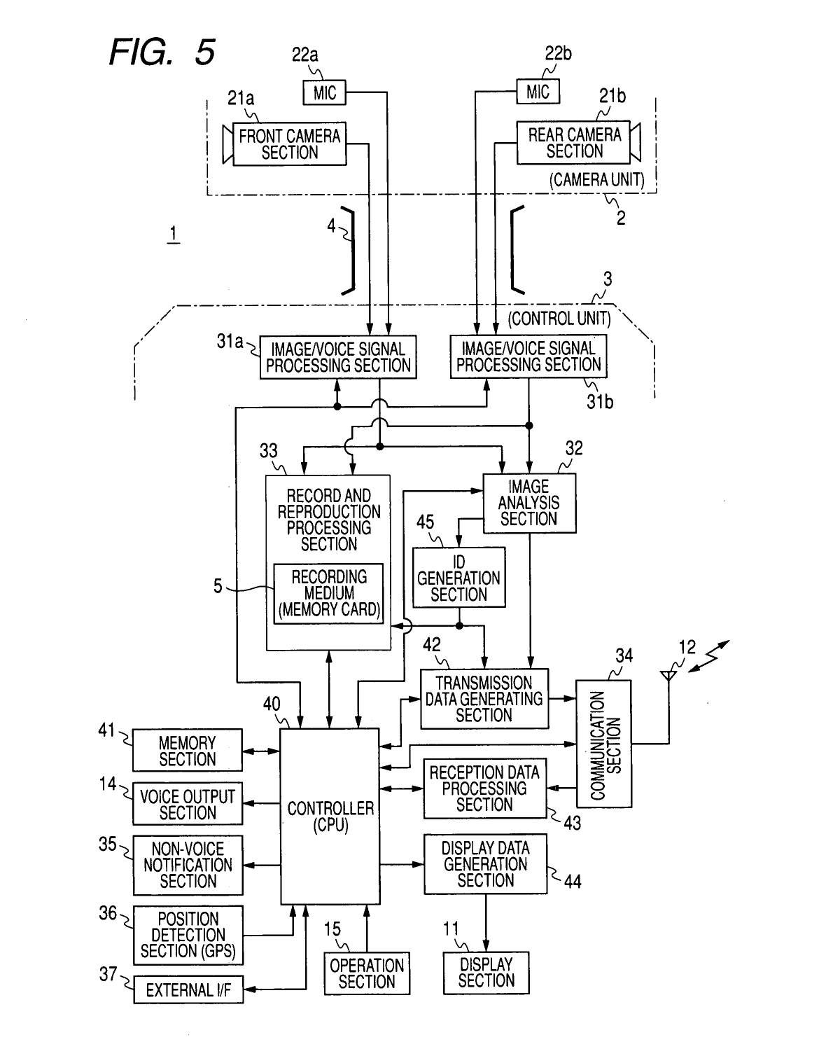

In FIG. 5, an internal configuration of the imaging device 1 is shown.

As described above, the camera unit 2 includes a front camera section 21a and a rear camera section 21b. The front camera section 21a and the rear camera section 21b are formed by an imaging optical lens system, a lens driving system, and an imaging device part formed by a CCD sensor or a CMOS sensor, respectively.

The lights for the images picked up by the front camera section 21a and rear camera section 21b are converted into imaging signals by internal imaging element parts, respectively. A predetermined signal processing is performed on the imaging signals such as gain control and the imaging signals are supplied to the control unit 3 through the cable 4.

In addition, the voice signals acquired by the front microphone 22a and the rear microphone 22b are supplied to the control unit 3 through the cable 4.

In the control unit 3, a controller (CPU: Central Processor Unit) 40 controls the overall operation. The controller 40 controls each unit in response to an operation program or a user's operation from the operation section 15 for various operations to be described later.

A memory section 41 is a storage device used for storing a program code which is executed in the controller 40 or temporarily storing data for an operation in execution. In the figure, the memory section 41 includes both a volatile memory and a nonvolatile memory. For example, the memory section 41 includes a ROM (Read Only Memory) which stores a program, a RAM (Random Access Memory) which is used for storing an operation work area or various temporarily storages, and a nonvolatile memory such as an EEP-ROM (Electrically Erasable and Programmable Read Only Memory).

An image signal pick up by the front camera section 21a and a voice signal generated by the front microphone 22a which are transmitted from the camera unit 2 through the cable 4 are input to an image/voice signal processing section 31a.

In addition, an image signal picked up by the rear camera section 21b and a voice signal generated by the rear microphone 22b are input to an image/voice signal processing section 31b.

The image/voice signal processing sections 31a and 31b perform an image signal process (brightness process, color process, a correction process, and the like) or a voice signal process (equalization, level adjustment, and the like) on the input image signal (and a voice signal) to generate image data and audio data as signals picked up by the camera unit 2.

An imaging operation may be performed as inputting image data of one frame in response to a user's operation such as taking a picture or automatically, for example, inputting image data of one frame at a predetermined time interval sequentially.

The image data which has been processed by the image/voice signal processing sections 31a and 31b is supplied to an image analysis section 32 and a record and reproduction processing section 33, for example, as image data of one frame (still image data). The supply of the image data to the image analysis section 32 and the record and reproduction processing section 33 may be in response to a user's operation (for example, shutter operation) or may be performed automatically at a predetermined time interval.

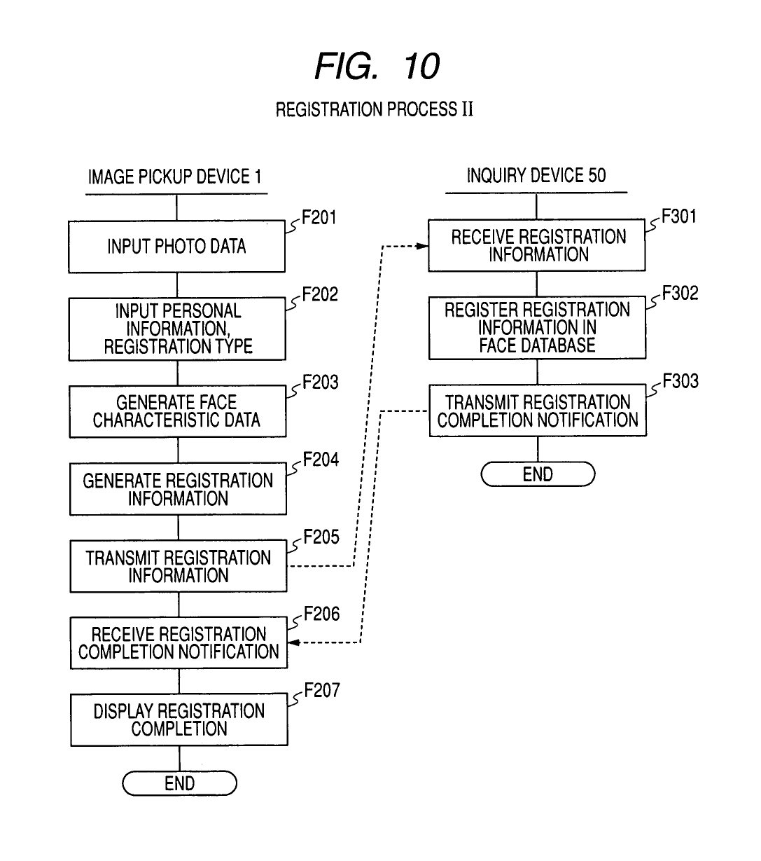

In a registration process, shown in FIG. 10, to be described later, image data of one sheet (one frame) is supplied to the image analysis section 32 in response to a user's operation.

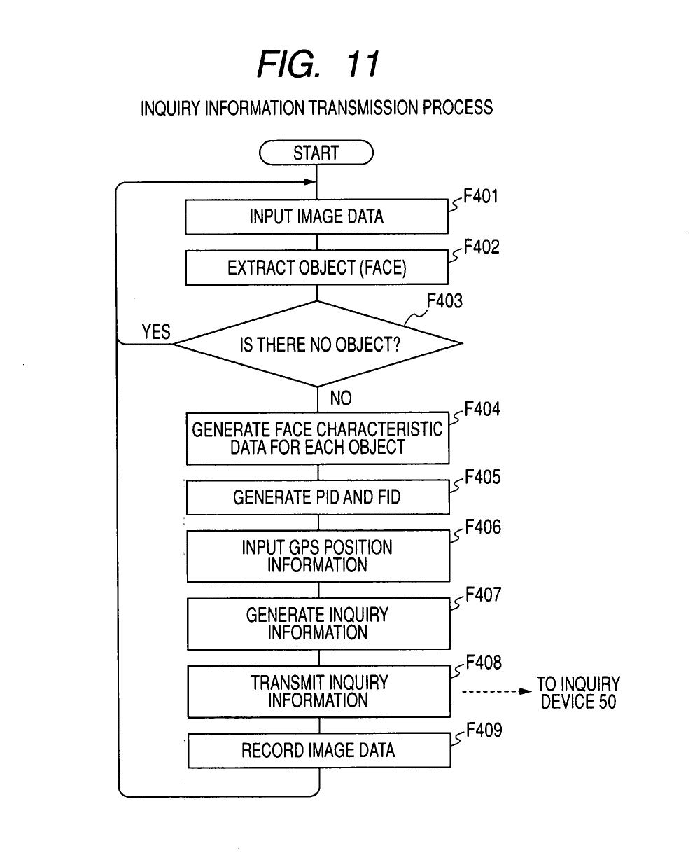

An inquiry information transmission process of FIG. 11 to be described later is automatically performed in policeman's patrol or the like. At this time, image data of one frame is supplied to the image analysis section 32 at each predetermined time interval. In this case, image data picked up by the front camera section 21a and image data picked up by the rear camera section 21b may be supplied to the image analysis section 32 by turns at each predetermined time interval.

The image analysis section 32 performs analysis on the supplied image data which has been processed by the image/voice signal processing sections 31a and 31b.

The image analysis section 32 performs a process of extracting a face image of a person from the image data as a target object and a process of generating face characteristic data from the extracted face image.

The record and reproduction processing section 33 performs a process of recording each supplied picked-up image data which has been processed by the image/voice signal processing sections 31a and 31b in a recording medium 5 (a memory card inserted into a memory card slot 13 shown in FIG. 1) as an image file or a process of reading an image file recorded in the memory card 5 based on the control of the controller 40.

In recording the image data, the record and reproduction processing section 33 performs a compression process on the image data according to a predetermined compression method or an encoding process in a recording format which is used for recording in the memory card 5. In addition, the record and reproduction processing section 33 forms an image file including information on an image ID (hereinafter, referred to as PID: Picture ID) which is assigned to each picked-up image data or a face ID which is assigned to each face image in the image data.

In reproducing, the record and reproduction processing section 33 extracts various information from a recorded image file or decodes image data.

An ID generation section 45 generates the PID and the FID. The PID is generated as specific identification information for the image data from which a face image is extracted based on the analysis result (result of face extraction) of the image analysis section 32. In addition, the FID is generated as specific identification information for each face image in the image data.

The generated PID and FID are supplied to the record and reproduction processing section 33 and a transmission data generating section 42.

The transmission data generating section 42 generates a data packet to be transmitted to the inquiry device 50. In other words, a data packet is generated as registration information or inquiry information. The registration information or the inquiry information include face characteristic data generated by the image analysis section 32, a PID, a FID, or the like to form an information packet.

The transmission data generating section 42 supplies the data packet as the registration information or the inquiry information to a communication section 34 for a transmission process.

The communication section 34 communicates with the inquiry device 50 through the network 90.

The communication section 34 performs a modulation process or an amplification process which may be required for a transmission process of the registration information or inquiry information generated by the transmission data generating section 42 and transmits the processed information wireless from an antenna 12.

In addition, the communication section 34 receives and demodulates the data which is transmitted from the inquiry device 50 and supplies the received data to a reception data processing section 43.

The reception data processing section 43 performs a buffering process, a packet decoding process, an information extraction process, or the like on the received data from the communication section 34 to supply the contents of the received data to the controller 40.

A display data generating section 44 generates display data as a content to be displayed in a display section 11 in accordance with a direction of the controller 40.

When the inquiry result information is transmitted from the inquiry device 50, the controller 40 directs the data contents as an image or a text to be displayed to the display data generating section 44 based on the inquiry result information. The display data generating section 44 drives the display section 11 based on the generated display data to perform a display operation.

In addition, the display data generating section 44 performs a process for displaying an operation menu or an operating status, for displaying the image which has been reproduced from the memory card 5, and for monitoring display of image signals picked-up by the front camera section 21a and the rear camera section 21b, although the signal paths are omitted in FIG. 5, in accordance with a direction of the controller 40.

The voice output section 14 includes a voice signal generating part which generates a voice signal such as an electronic sound and a voice message, an amplification circuit part, and a speaker. The voice output section 14 outputs a voice that may be required in accordance with a direction of the controller 40. For example, the voice output section 14 outputs a voice message or an alarm sound in various actions or operations or outputs a reception notifying sound that notifies a user of reception of inquiry result information.

In addition, although the paths of the signals are omitted in FIG. 5, by supplying the voice signals collected by the front microphone 22a and the rear microphone 22b to the voice output section 14 for output, monitoring voice in imaging or the like can be output.

A non-voice notification section 35 notifies, for example, a reception notice for receiving the inquiry information of a user in a format other than a voice in accordance with a direction of the controller 40. For example, the non-voice notification section 35 includes a vibrator and notifies the reception of inquiry information of a user (policeman) who wears the imaging device 1 by the vibration of the vibrator.

The operation section 15, as described with reference to FIG. 2, is an operation member for various operations which is disposed on a case body of the control unit 3. For example, the controller 40 displays a menu for various operations in the display section 11, and a user inputs an operation on the menu by operating a cursor or a enter-key using the operation section 15. The controller 40 performs a predetermined control in accordance with a user's operation using the operation section 15. For example, various controls for start/stop of an imaging operation, an operation mode, record and reproduction, communications, and the like can be performed in accordance with a user's operation.

Of course, the operation section 15 may not be an operation member corresponding to an operation menu in the display section 11 and, for example, may be provided as an imaging key, a stop key, a mode key, and the like.

A position detection section 36 includes a GPS antenna and a GPS decoder. The position detection section 36 receives a signal from a GPS (Global Positioning System) satellite, decodes the received signal, and outputs latitude and longitude as current position information.

The controller 40 can acquire the current position based on the latitude and longitude transmitted from the position detection section 36. The controller 40 can supply the transmission data generation section 42 the current position information to be included in a data packet as inquiry information and can compare the position information included in the inquire result information to the current position information.

An external interface connects to external devices for various communications. For example, the external interface can perform data communication with an external device according to a predetermined interface standard such as USB or IEEE 1394. For example, upload for upgrading an operation program of the controller 40, transmission of data reproduced from the memory card 5 to an external device, and input of various information in a registration process to be described later can be performed.

According to the above-described configuration, a registration process, a transmission process of inquiry information, and a reception process of inquiry result information, which will be described later, can be performed in the imaging device 1. Accordingly, the controller 40 controls imaging operations of the camera unit 2 and the image/voice signal processing sections 31a and 31b, recording and reproducing operations of the record and reproduction section 33, operations of the record and reproduction processing section 33 operations for face extraction and generation of face characteristic data of the image analysis section 32, operations for generating the registration information and inquiry information of the transmission data generation section 42, a communication operation of the communication section 34, a display data generating operation of the display data generation section 44, and operations of the voice output section 14 and non-voice notification section 35.

Although the imaging device 1 in this example is configured as described above, as an example, but modified examples may be configured as follows.

Each block as a configuration element shown in FIG. 5 is not an essential element, and an additional element may be added to the configuration.

Although the image analysis section 32, the ID generation section 45, the transmission data generation section 42, the reception data processing section 43, and the display data generation section 44 may be configured as separate circuit sections other than the controller 40 (CPU), respectively which are implemented as hardware, as shown in FIG. 5, the process of each of the sections may be implemented as an operation process of software or as a function implemented by a software program included in the controller 40.

In addition, the appearances of the camera unit 2 and the control unit 3 shown in FIG. 2 are, of course, according to an exemplary embodiment, and an operation member for a user interface, display arrangement, a shape of a case, and the like which are configured actually are not limited thereto. Of course, based on the difference of the configuration, any varied shape may be adopted.

Although the camera unit 2 and the control unit 3 are connected with a cable 4 in the embodiment, a picked up image signal or a voice signal may be transmitted wireless by a transmitter using electric waves or infrared rays.

Alternatively, the camera unit 2 and the control unit 3 may be formed together as one structure instead of separate structures shown in FIG. 1.

In addition, the display section 11 may be formed as a separate case body, and, for example, a wrist watch type display section may be used or the control unit 3 may be a wrist watch type, considering the visibility of a policeman or the like.

In the example, the front camera section 21a and the rear camera section 21b are included, but at least one camera section may be included.

Three or more camera sections may be included.

Each microphone may be included corresponding to each of the two or three or more camera sections configured, and alternatively, a common microphone for the total or partial camera sections may be used. Of course, at lease one microphone may be included.

In addition, for the total or partial camera sections of one or more, one or more pan tilt mechanisms may be formed to be able to change the direction of imaging/down or to the left/right.

The pan and tilt operation may be performed in accordance with a user's operation or may be automatically controlled by the controller 40.

Although in the example, a memory card 5 is used as an example of the recording medium, the recording medium is not limited to the memory card 5, and for example, a HDD (Hard Disc Drive) may be built in the record and reproduction processing section 33 or a medium such as an optical disc or an optical magnetic disk may be used. Of course, a magnetic tape medium may be used as the recording medium.

3. Configuration of Inquiry Device

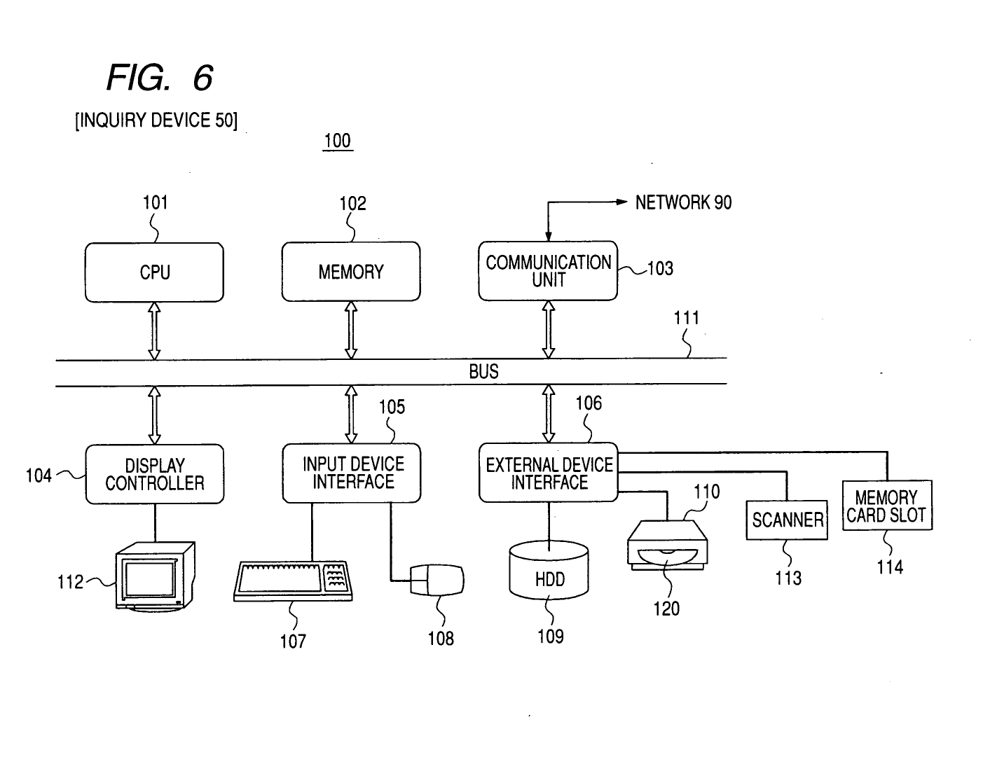

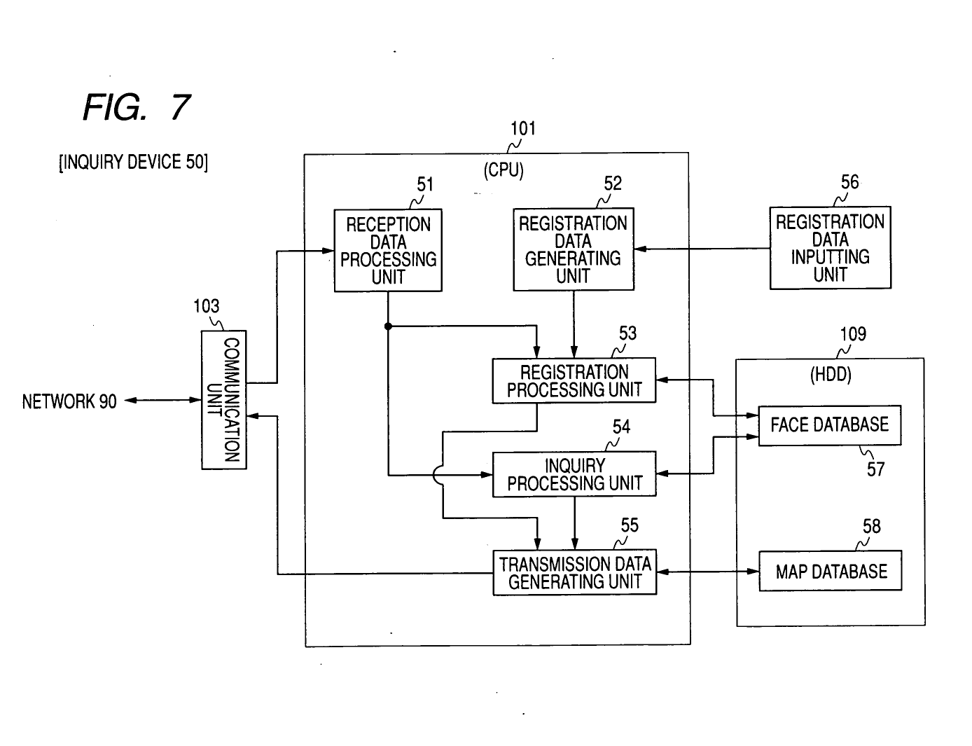

Hereinafter, the configuration of the inquiry device 50 is described with reference to FIGS. 6 and 7. The inquiry device 50 may be implemented in hardware by using a personal computer or a computer system as a workstation. At first, the configuration of a computer system 100 which can be used as the inquiry device 50 will be described with reference to FIG. 6, and the functional configuration as the inquiry device 50 will be described with reference to FIG. 7.

FIG. 6 is a schematic diagram showing an exemplary hardware configuration of the computer system 100. As shown in the figure, the computer system 100 includes a CPU 101, a memory 102, a communication unit (network interface) 103, a display controller 104, an input device interface 105, an external device interface 106, a keyboard 107, a mouse 108, a HDD (Hard Disc Drive) 109, a media drive 110, a bus 111, a display device 112, a scanner 113, and a memory card slot 114.

The CPU 101 which is a main controller of the computer system 100 is configured to execute various applications under the control of an operating system (OS). For example, when the computer system 100 is used as an inquiry device 50, applications implementing functions of a reception data processing unit 51, a registration data generating unit 52, a registration processing unit 53, an inquiry processing unit 54, and a transmission data generating unit 55 which will be described later with reference to FIG. 7 are executed by the CPU 101.

As shown in the figure, the CPU 101 is connected to other devices (to be described later) with the bus 111. To each device on the bus 111, a proper memory address or an I/O address is assigned, and the CPU 101 can access other devices by the addresses. An example of the bus 111 is a PCI (Peripheral Component Interconnect) bus.

The memory 102 is a storage device which is used for storing program codes executed in the CPU 101 or temporarily storing work data in execution. In the figure, the memory 102 includes both a volatile memory and a nonvolatile memory. For example, the memory 102 includes a ROM which stores a program, a RAM (Random Access Memory) which is for storing an operation work area or various temporarily storages, and a nonvolatile memory such as an EEP-ROM.

The communication unit 103 can connect the computer system 100 to the network 90 that communicates with the imaging device 1 through the Internet, a LAN (Local Area Network), a dedicated line, or the like using a predetermined protocol such as “ETHERNET®”. Generally, the communication unit 103 as a network interface is provided as a LAN adapter card and is inserted into a PCI bus slot of a mother board (not shown). Alternatively, the communication unit 103 may be connected to an external network through a modem (not shown) instead of a network interface.

The display controller 104 is a dedicated controller for actually executing a drawing command which is issued by the CPU 101. For example, the display controller 104 supports for a bitmap drawing command corresponding to an SVGA (Super Video Graphic Array) or an XGA (extended Graphic Array). The drawing data which has been processed by the display controller 104, for example, is temporarily written in a frame buffer (not shown) and outputs to a screen of the display device 112. An example of the display device 112 is a CRT (Cathode Ray Tube) display or a liquid crystal display.

The input device interface 105 is a device for connecting a user input device such as the keyboard 107 or the mouse 108 to the computer system 100. In other words, an operation for input which may be required for the operation of an operator who is responsible for the inquiry device 50 in a police station or the like or the operation for the registration of the face database is performed by the keyboard 107 and the mouse 108 in the computer system 100.

The external device interface 106 is a device for connecting an external device such as a HDD (Hard Disc Drive) 109, a media drive 110, a scanner 113, and a memory card slot 114 to the computer system 100. The external device interface 106 is, for example, based on an interface standard such as IDE (Integrated Drive Electronics) or SCSI (Small Computer System Interface).

The HDD 109 is, as well known, is an external storage device including a fixed magnetic disk as a recording medium and has superior characteristics of the storage amount or data transmission speed to other external storage devices. To place a software program in the HDD 109 in an executable status is called “installation” of the program to the system. Generally, a program code of an operating system, an application program, a device driver, or the like which is to be executed by the CPU 101 is stored nonvolatile in the HDD 109.

For example, an application program for each function to be executed by the CPU 101 is stored in the HDD 109. In addition, a face database 57 and a map database 58 are constructed in the HDD 109.

The media drive 110 is a device for loading the portable medium 120 such as a CD (Compact Disc), an MO (Magneto-Optical disc), or a DVD (Digital Versatile Disc) to access the data recording face. The portable medium 120 is mainly used for backing up a software program or a data file as computer readable format data or moving (including sales, circulation or distribution) the program or data file between systems.

For example, applications implementing functions described with reference to FIG. 7 or the like may be circulated or distributed using the portable medium 120.

The scanner 113 reads an image. For example, a photograph may be set in a scanner 113 for inputting the image data of the photograph.

The memory card slot 114 is a memory card record and reproduction unit, for example, for the memory card 5 which records and reproduces for the memory card 5, as described above, used for the imaging device 1.

As an example, a functional configuration of the inquiry device 50 constructed by using the computer system 100 is shown in FIG. 7.

In FIG. 7, the communication unit 103, the CPU 101, and the HDD 109 are represented which are shown in FIG. 6, and a processing function executed by the CPU 101 and a database constructed in the HDD 109 are shown.

As a functional configuration executed by the CPU 101, a reception data processing unit 51, a registration data generating unit 52, a registration processing unit 53, an inquiry processing unit 54, and a transmission data generating unit 55 are provided. As an example, by executing an application program implementing the function in the CPU 101, the functional configuration is implemented.

The face database 57 and the map database 58 are constructed in the HDD 109.

A registration data input unit 56 collectively represents portions for inputting registration information of the face database 57. For example, the keyboard 107, the mouse 108, the scanner 113, the memory card slot 114, and the media drive 110 which are shown in FIG. 6 and the like may be used as the registration data input unit 56.

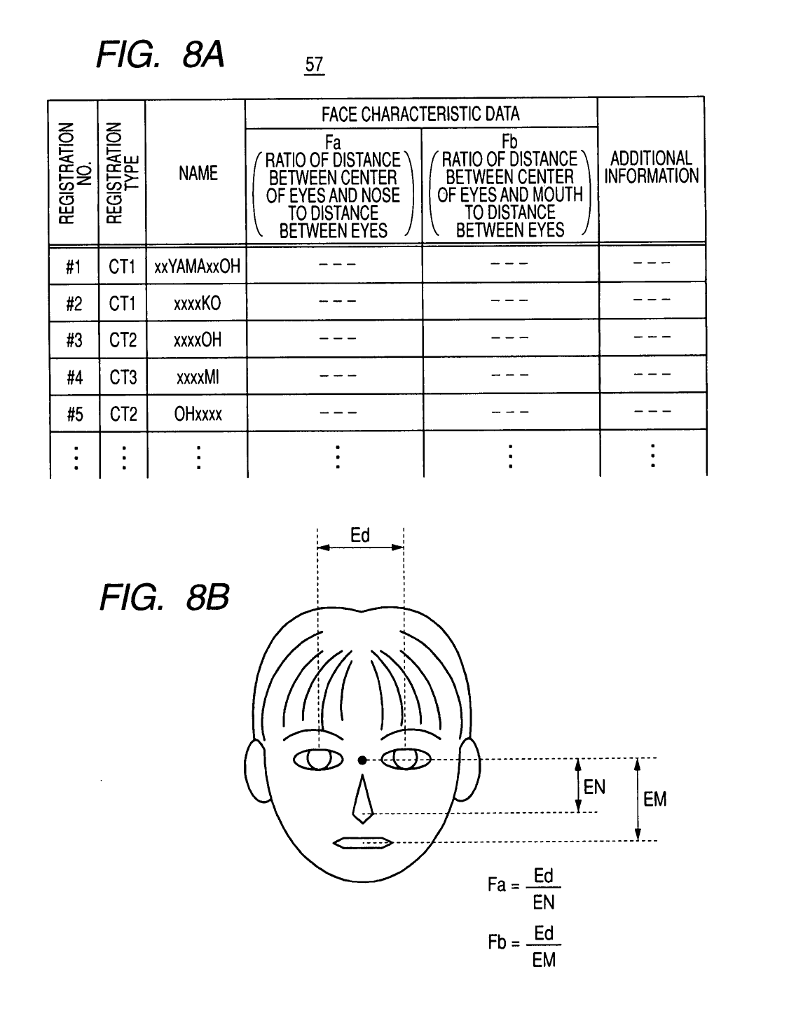

Before the functions shown in FIG. 7 are described, an example of the face database 57 will now be described with reference to FIGS. 8A and 8B. An exemplary configuration of the face database 57 is shown in FIG. 8A.

The persons to be searched for are registered in the face database 57 as registration numbers #1, #2, etc.

The registration types CT1, CT2, etc. are types of the registration, and, for example, represents a type such as a missing person, a wanted person, or a reference person.

The name, face characteristic data, and additional information are registered for each person as personal information.

The face characteristic data is information on relative positions of face components. Here in the example, face characteristic data Fa and face characteristic data Fb are registered.

The face characteristic data Fa is, as shown in FIG. 8B, set to a ratio of the distance between eyes Ed to a distance EN between the center of the eyes and a nose. For example, Fa=Ed/En.

The face characteristic data Fb is set to a ratio of the distance between the eyes Ed to a distance EM between the center of the eyes and a mouth. For example, Fb=Ed/EM.

The information on the relative positions of the face components is information unique to a person and is not influenced by an appearance change according to an attachment such as a hair style or glasses. In addition, it is known that the information on the relative positions does not change with age.

When the face characteristic data as the registration information of the face database 57 is the face characteristic data Fa and Fb, the above-described face characteristic data generated by the image analysis section 32 of the imaging device 1 is the face characteristic data Fa and Fb.

Additional information is other various information on a person for registration. For example, sex, date of birth, age at a registration time, height, color of eyes, an address, the reason for registration, and the like may be the additional information. In addition, the additional information may include link information for a database including a criminal record, fingerprint data, or the like.

The inquiry device 50 shown in FIG. 7 has a functional configuration for performing an inquiry process using the face database 57.

The communication unit 103 performs data communication with the communication section 34 of the imaging device 1. The communication unit 103 performs a reception process in response to the transmission of registration information or inquiry information from the imaging device 1.

While the inquiry result information is transmitted from the inquiry device 50 to the imaging device 1, the communication unit 103 transmits the inquiry result information in response to the direction of the CPU 101.

The reception data processing unit 51 performs a buffering process or an information content extraction process on the received data packet which has been transmitted from the communication unit 103 as registration information or inquiry information.

The registration data generating unit 52 generates registration data to be registered in the face database 57. The registration data is information contents to be recorded for each registration number in the face database 57. In other words, the registration data is a registration type and personal information (name, face characteristic data Fa and Fb, and additional information).

The registration type or the personal information may be input from the registration data inputting unit 56 or generated by the registration data generating unit 52 based on the input.

For example, for the registration type or the name, and additional information, the information input from the registration data inputting unit 56 is used. For example, the information may be input by an operation of the keyboard 107 or the like or by reading the personal information or the like which is recorded in the memory card or the portable media 120 is read into the memory card slot 114 or the media drive 110.

When image data of a face is input from the scanner 113, the memory card slot 114 (memory card), or the media drive 110 (portable media 120) as the registration data inputting unit 56, the registration data generating unit 52 generates the face characteristic data Fa and Fb by performing a data analysis on the image data.

The registration data generating unit 52 generates the registration information of the face database 57 using this information.

The registration processing unit 53 performs a registration process in the face database 57.

When the registration information is generated by the registration data generating unit 52, the registration information is written in the face database 57 by the registration processing unit 53 to complete the registration of one record. On the other hand, when the registration information is transmitted from the imaging device 1, the reception data processing unit 51 supplies the registration information to the registration processing unit 53. In this case, the registration information is written in the face database 57 by the registration processing unit 53 to complete the registration of one record.

The inquiry processing unit 54 performs an inquiry process by searching the face database 57. When the inquiry information is transmitted from the imaging device 1, the reception data processing unit 51 supplies the inquiry information to the inquiry processing unit 54. In this case, the inquiry processing unit 54 searches the face database 57 using the face characteristic data Fa and Fb included in the inquiry information for determining whether the corresponding face characteristic data Fa and Fb exist in the face database or reading the registration type or personal information of a corresponding person.

The transmission data generating unit 55 generates inquiry result information based on the inquiry processing result of the inquiry processing unit 54. In other words, the transmission data generating unit 55 generates inquiry result information including the PID and FID which are included in the personal information corresponding to the searched person or the inquiry information transmitted from the imaging device 1. The inquiry result information includes the detailed position information. The detailed position information is read by searching the map database 58 based on the position information (latitude and longitude) which is included in the inquiry information. The detailed position information is generated by using a map image or text to be included in the inquiry result information.

The inquiry result information which has been generated by the transmission data generating unit 55 is transmitted to the imaging device 1 by the communication unit 103.

4. Registration Process of Face Database

Hereinafter, the operations performed by the imaging device 1 and the inquiry device 50 will be described. At first, the registration process of the face database 57 will be described.

In this example, the registration of a person in the face database 57 including an exemplary registration process in which the registration information is input by the inquiry device 50 and an exemplary registration process in which the registration information is transmitted from the imaging device 1 and registered by the inquiry device 50 will be described.

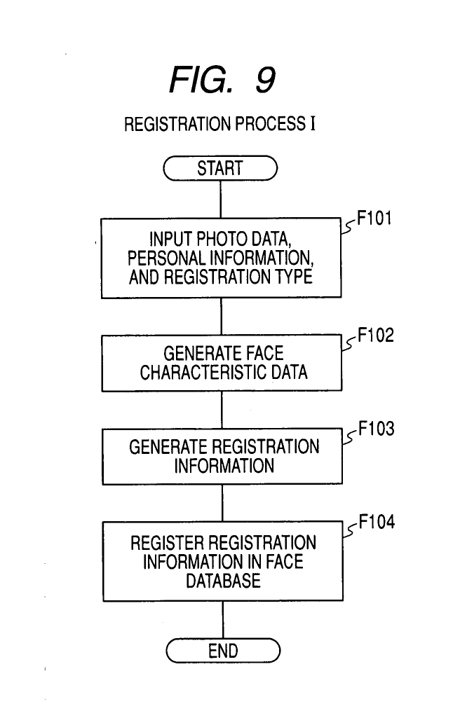

The registration process I shown in FIG. 9 is an example for performing registration by the inquiry device 50 based on an operation of an operator.

In a step F101, a face photo data, various personal information, and the registration type of a person to be registered by the registration data inputting unit 56 are input. The input of the face photo data can be performed, for example, by inputting a photo as image data using the scanner 113, reading face photo data recorded in the portable media 120 or the memory card 5, or the like. Alternatively, a technique of downloading face photo data from an external computer system or an external database through communication using the communication unit 103 may be used.

The name, sex, age, address, and the like as the registration type or personal information are input by an operation of an operator who performs an operation for the registration using the keyboard 107 or the mouse 108. Of course, the registration type or the personal information may be input from an external database.

In a step F102, the registration data generating unit 52 generates face characteristic data Fa and Fb by analyzing the input face photo data. In other words, the registration data generating unit 52 extracts a face image part from the face photo data, determines a distance between eyes, a distance between the center of the eyes and a nose, and a distance between the center of the eyes and a mouth, and generates face characteristic data Fa and Fb as relative position information of the face components.

In a step F103, the registration data generating unit 52 generates registration information. In other words, the input registration type, the input name, sex, age, address and the like as the personal information, and the generated face characteristic data Fa and Fb are set as registration information of the face database 57. The registration data generating unit 52 transmits/receives the registration information to/from the registration processing unit 53.

In a step F104, the registration processing unit 53 additionally registers the transmitted registration information in the face database 57 by attaching a new registration number.

By the above-mentioned processes, the registration of one record is performed.

The registration process II shown in FIG. 10 is an example for performing registration by transmitting registration information from the imaging device 1. In FIG. 10, a process of the imaging device 1 and a process of the inquiry device 50 are shown.

This technique, for example, is appropriate, for a case in which a search request for a missing person is received, a policeman is provided with a photo from a relative of the missing person or the like, and a registration process in the face database 57 is immediately performed.

In a step F201 shown in FIG. 10, photo data is input to the imaging device 1. For example, the photo data is input by a policeman's imaging of a photo which is provided from the missing person's family or the like together with a search request using the imaging device 1. The face photo data is input by the policeman's imaging operation using the imaging device 1. Of course, when a family member or the like has photo data of the missing person taken by a digital still camera, the photo data may be input by connecting the digital still camera, a personal computer, or the like of the family member to the external interface 37. Alternatively, the photo data may be provided using the memory card 5, and the memory card 5 may be loaded into the memory card slot 114, so that the photo data can be read by the record and reproduction processing section 33.

In a step F202, the name, sex, age, address, and the like as the personal information and the registration type are input. For example, the controller 40 displays an input screen for registration in the display section 11. A policeman inputs the registration type, the name, or the like using the operation section 15 in accordance with the display of the display section 11. The controller 40 receives the input name, etc. Of course, the personal information such as the name may be input from the external interface 37 or the memory card 5.

In a step F203, the face characteristic data Fa and Fb is generated by the image analysis section 32 in accordance with a direction of the controller 40. In other words, the face photo data which is input in the step F201 is supplied to the image analysis section 32, the image analysis section 32 extracts a face image part from the face image data, determines a distance between eyes, a distance between the center of the eyes and a nose, and a distance between the center of the eyes and a mouth, and generates face characteristic data Fa and Fb as relative position information of the face components.

In the next step F204, registration information is generated by the transmission data generating section 42. The transmission data generating section 42 collects face characteristic data Fa and Fb which is generated by the image analysis section 32 in the step F203 and the name, sex, age, address, and the like which are input in the step F202 to generate a data packet and generates registration information to be transmitted to the inquiry device 50.

The controller 40 transmits the registration information to the inquiry device 50 using the communication unit 34 in a step F205.

In the inquiry device 50, when the registration information is received from the imaging device 1 in a step F301, the reception data processing unit 51 transmits/receives the registration information to/from the registration processing unit 53.

In a step F302, the registration processing unit 53 additionally registers the transmitted registration information in the face database 57 by attaching a new registration number.

By the above-mentioned processes, the registration of one record is performed. In accordance with the completion of the registration, the registration processing unit 53 notifies a transmission request for registration completion notification and the information of the imaging device 1 which has transmitted the registration information of the transmission data generating unit 55 in a step F303. In response to this notification, the transmission data generating unit 55 generates transmission data as the registration completion notification and transmits the registration completion notification from the communication unit 103 to the imaging device 1.

When the imaging device 1 receives the registration completion notification in the step F206, the controller 40 directs the display data generating unit 44 to display a mark which indicates the completion of registration to a user in the display section 11.

By performing the above-described processes, the registration can be made even in an onsite location of a policeman, and accordingly the registration in the face database 57 can be made quickly. Accordingly, the processing of the inquiry to be described later can be effectively performed for searching for a missing person or the like.

5. Imaging Operation and Transmission of Inquiry Information of Imaging Device

Hereinafter, processes for performing an inquiry on a person using the face database 57 in the imaging device 1 and the inquiry device 50 will be described.

At first, processes performed until the imaging device 1 transmits inquiry information to the inquiry device 50 will be described with reference to FIGS. 11 to 16.

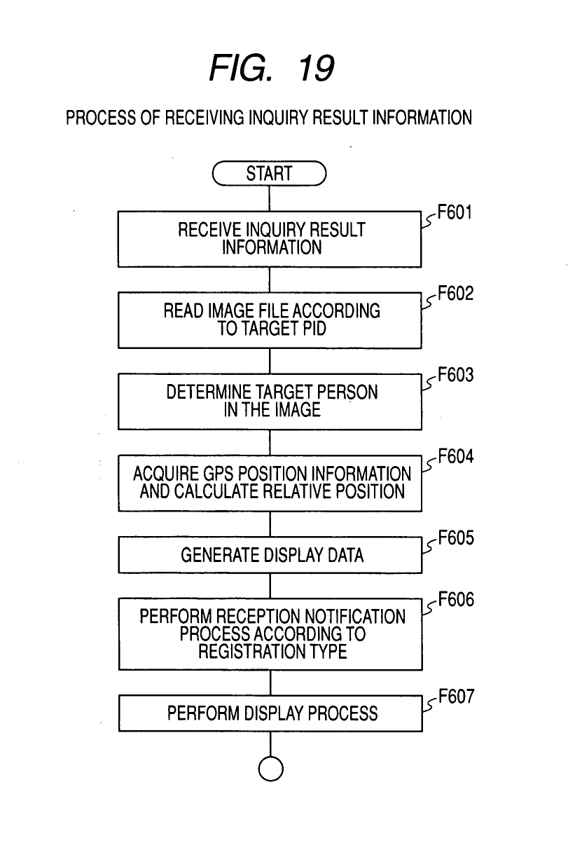

The process shown in FIG. 11, for example, is automatically performed repeatedly at a predetermined time interval when a policeman performs a patrol or the like with wearing the imaging device 1. For example, by switching the operation of the imaging device 1 to an automatic inquiry mode or the like, the process shown in FIG. 11 (and the process shown in FIG. 19 to be described later) is performed.

Input of the picked up image data of a step F401 is performed at each predetermined time interval (for example, an interval of one second to several seconds). This process is to input image data of one frame as picked-up image data which is picked up by the camera unit 2 and processed by the image/voice signal processing section 31a or 31b to the image analysis section 32 and the record and reproduction processing section 33 at each predetermined time interval as still-screen data.

In response to the input of the picked-up image, the image analysis section 32 performs a process of a step F402 based on the control of the controller 40.

In the step F402, the image analysis section 32 analyzes the picked-up image data which has been input and extracts a face image as a target object.

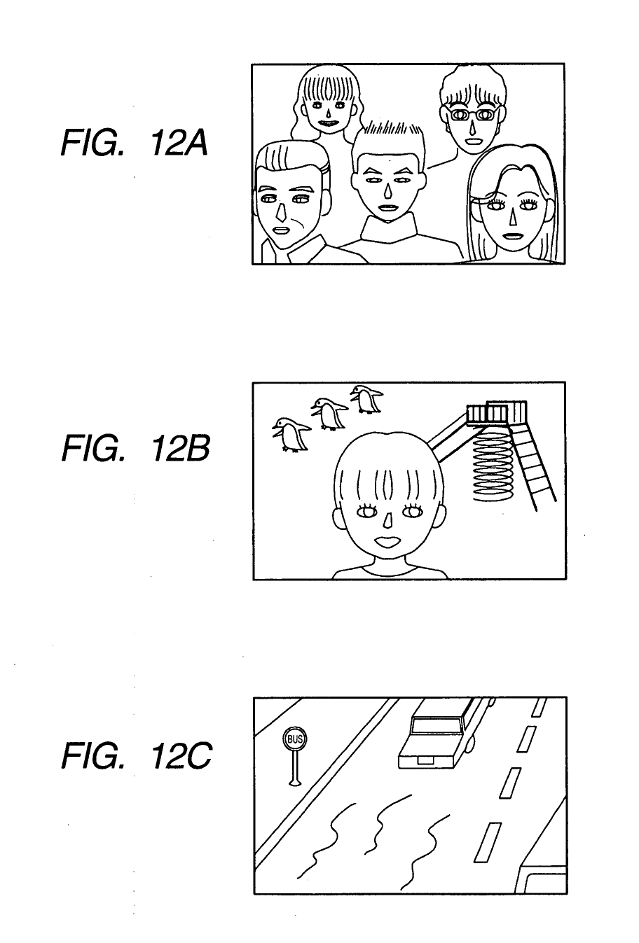

The picked-up image data which is input automatically and sequentially at a predetermined time interval, for example, in patrol may include various image contents. For example, the picked-up image data may be one of various images such as an image including faces of a plurality of persons as shown in FIG. 12A, an image including a face of one person as shown in FIG. 12B, and an image not including any face of a person as shown in FIG. 12C.

Thus, the image analysis section 32 determines whether any face image is included in the picked-up image data, at first. For example, when the picked-up image data as shown in FIG. 12C is input and the image analysis section 32 analyzes the image data and determines that the image data does not include any face image, it is determined that there is no target object to be processed in a step F403, and the image analysis section 32 transmits the information to the controller 40. At this time, the controller 40 ends the process for the pick-up image data and returns the process to the step F401. Then, after a predetermined time, the process of inputting a picked-up image is performed again.

When the input picked-up image data includes an image as shown in FIG. 12A or 12B and one or more face images are extracted, the process is moved from the step F403 to a step F404, and the face characteristic data Fa and Fb is generated by the image analysis section 32. In other words, the image analysis section 32 determines a distance between eyes, a distance between a center of the eyes and a nose, and a distance between the center of the eyes and a mouth from each of the extracted face images and generates face characteristic data Fa and Fb as relative position information of the face components.

In this case, the face characteristic data Fa and Fb is generated for each of the extracted face images. For example, since five faces of persons are included in the image data of FIG. 12A, face characteristic data Fa and Fb is generated for each person.

In a step F405, the ID generation section 45 generates a PID and an FID in response to the extraction of the face image in the image analysis section 32.

The PID and the FID generated by the ID generation section 45 are supplied to the transmission data generating section 42 and the record and reproduction processing section 33.

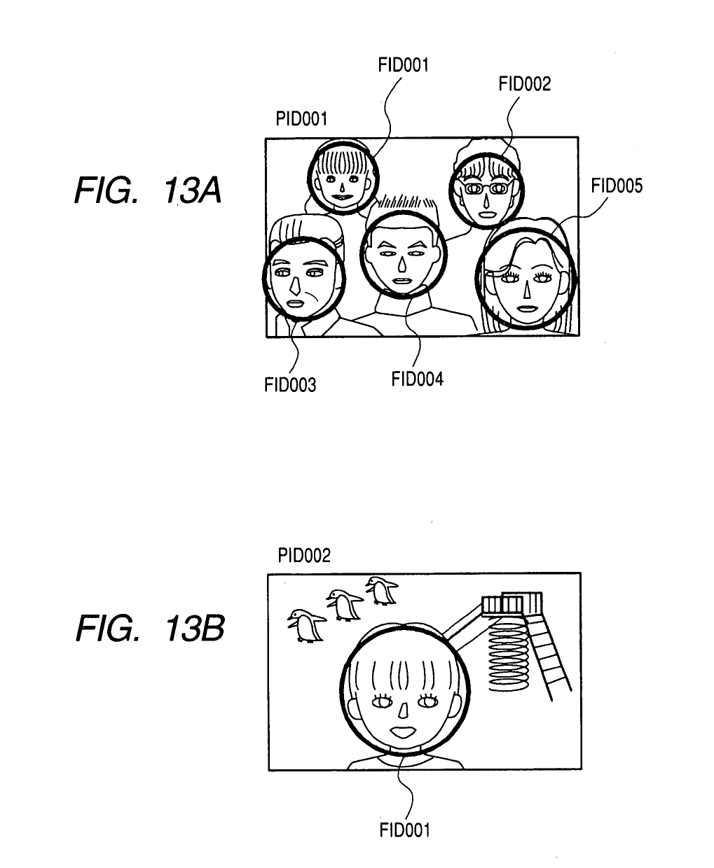

The PID (image ID), for example, is uniquely assigned to picked-up image data including a face image, and a new ID code is generated whenever picked-up image data which is determined to include a face image by the image analysis section 32 is generated. For example, when the picked-up image data of FIG. 12A is processed, image identification information of “PID001” as a PID corresponding to the picked-up image data is generated, as shown in FIG. 13A. In addition, for example, when the picked-up image data of FIG. 12B is processed at a different time point, image identification information of “PID002” as a PID corresponding to the picked-up image data is generated, as shown in FIG. 13B.

For example, a serial number which is uniquely assigned to the imaging device 1 and a value such as “year/month/date/hour/minute/second/frame” as imaging time may be combined to form a unique code as a PID code.

Since the PID is included in the inquiry information to be transmitted to the inquiry device 50 as descried below, when identification information of the imaging device 1 such as a serial number of the imaging device 1 is included in the PID, the PID can be used not only as identification information which identifies picked-up image data but also as identification information which identifies the imaging device 1 (an imaging device which transmits inquiry information from the viewpoint of the inquiry device 50) used.

The FID (face ID) is assigned to each face image which is extracted from one picked-up image data by the image analysis section 32.

For example, a circle is drawn on each face image part extracted from the picked-up image data in FIG. 13A, and one of the FIDs FID001 to FID005 is assigned to each face image. When only one face image is extracted from the picked-up image data as in FIG. 13B, an FID FID001 is assigned to the face image.

The FID is assigned corresponding to a coordinate of a center pixel of a face part which is denoted by a circle in the image or a radius of the circle, that is, information on the extracted range as a face image.

In a step F406, the controller 40 inputs the latitude and longitude information as current position information which is detected by the position detection section 36. The input information becomes position information indicating the picked-up location of the picked-up image data in processing.

In a step F407, the controller 40 directs the transmission data generating section 42 to generate inquiry information. To the transmission data generating section 42, the position information which is transmitted from the controller 40 and the face characteristic data Fa and Fb which is generated by the image analysis section 32, and the PID and FID which are generated by the ID generation section 45 are supplied.

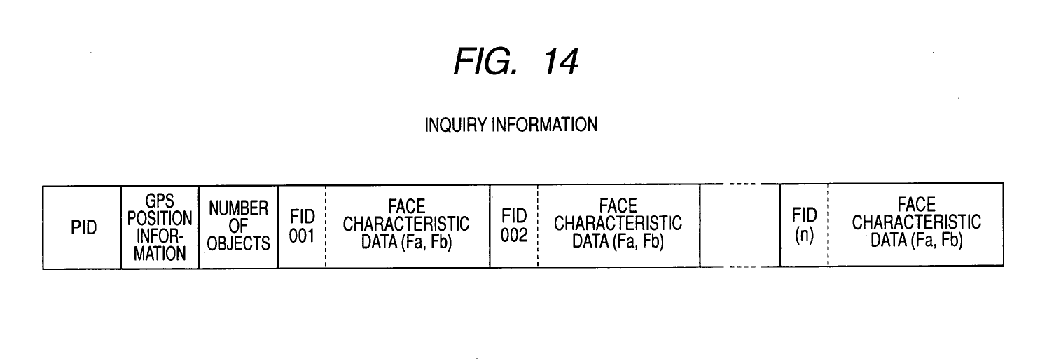

The transmission data generating section 42 generates a data packet, for example, as inquiry information as shown in FIG. 14 using the transmitted information.

As shown in FIG. 14, the inquiry information includes a PID assigned to the picked-up image data in processing and the position information (latitude and longitude) detected by the position detection section 36. As the number of objects, the number of face images extracted from the picked-up image data is represented, and an FID and corresponding face characteristic data Fa and Fb are repeatedly included, following the number of the objects. For example, when the picked-up image data includes face images of five persons as shown in FIG. 13A, the number of objects becomes five, and accordingly, face characteristic data Fa and Fb of the FID FID001 to face characteristic data Fa and Fb of the FID FID005 are included in the inquiry information. On the other hand, when the picked-up image data includes a face image of one person as shown in FIG. 13B, the number of objects becomes one, and accordingly, face characteristic data Fa and Fb of the FID FID001 is included in the inquiry information.

When the inquiry information is generated by the transmission data generating section 42, transmission of the inquiry information from the communication section 34 is performed by the control of the controller 40 in a step F408. In other words, the inquiry information as shown in FIG. 14 is transmitted to the inquiry device 50.

Next in a step F409, the controller 40 directs the record and reproduction processing section 33 to record the picked-up image data in a recording medium (memory card 5) as a file.

The record and reproduction processing section 33 performs a compression process which may be required or an encoding process based on the recording format of the memory card 5 on the picked-up image data in processing.

In addition, the record and reproduction processing section 33 acquires the PID and FID from the ID generation section 45. For the FID, the record and reproduction processing section 33 additionally acquires FID related information which represents a face image part to which the FID is assigned in the image.

To the acquired information, file attribute information (header information) is added to form one image file, and the image file is recorded in the memory card 5.

After the controller 40 directs the recording process to the record and reproduction processing section 33, the controller 40 moves back to the step F401, and the controller 40 starts controlling the processes from the step F401 after a predetermined time.

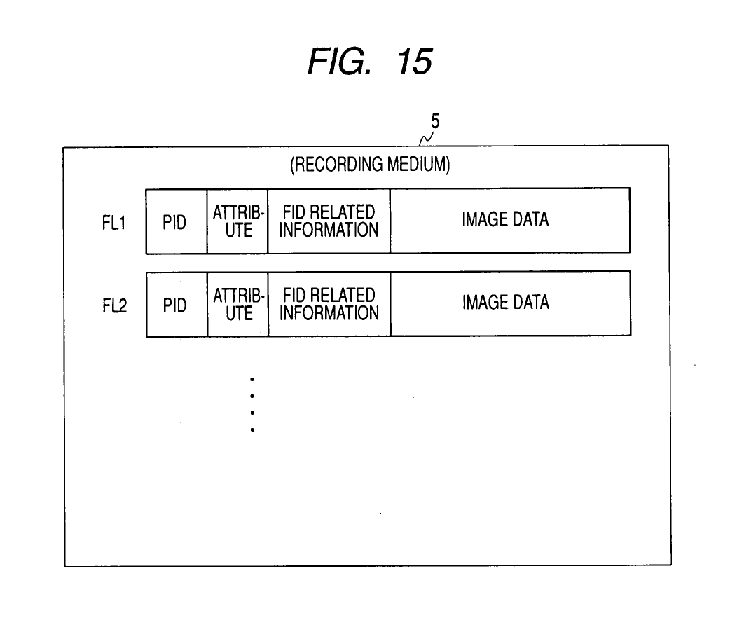

By the operation of the step F409, one image file FL is recorded, and by repeating the process shown in FIG. 11, image files FL1, FL2, and so on are sequentially recorded in the memory card 5, for example, in a format shown in FIG. 15.

In one image file FL, for example, a PID, attribute information, FID related information, and image data are included as shown in the figure. Alternatively, the above-described information may be recorded in a managed status in which the above-described information is linked.

The image data is the picked-up image data on which encoding such as compression is performed.

The PID may be also used as a file name of the image file FL.

The attribute information includes a file name, a file size, an image format, imaging date and time, and offset addresses or link information for the above-described information. The position information acquired in the step F406 may be included in the attribute information.

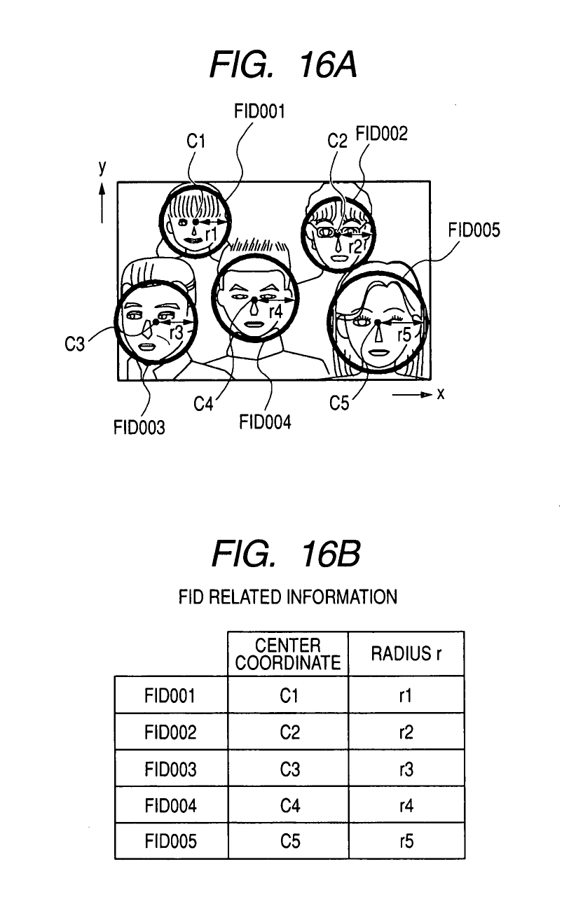

The FID related information, for example, is shown in FIGS. 16A and 16B.

As described above, an FID is assigned to each face image which is extracted from one picked-up image data by the image analysis section 32, and FIDs are assigned to circled image parts, respectively as shown in FIG. 16A.

In this example, the FID may be required to be managed as a pixel coordinate position of each face image in the picked-up image data. In order to do this, for example, circled regions of FIG. 16A may be managed to be related with FIDs, respectively. In FIG. 16A, when the picked-up image data is recognized in an xy pixel coordinate, center coordinates of circles as face parts represented in x, y coordinates are represented as C1, C2, C3, C4, and C5, respectively. In addition, the ranges of the circles from the centers, that is, the ranges of regions of the extracted face parts are represented as radiuses r1, r2, r3, r4, and r5.

The FID related information may be a center coordinate and a value of a radius r related with each FID, as shown in FIG. 16B.

When the FID related information is recorded, it becomes possible to identify a face, for example, of the FID002 in the image of PID001 later.

Accordingly, as described above, the ID generation section 45 generates the FID related information corresponding to a center coordinate or a pixel range of an extracted region as the result of the face extraction of the image analysis section 32, and the record and reproduction section 33 records the FID related information.

The content of the FIG related information is not limited to the center coordinate or the radius and may be configured appropriately for a processing method such as a process of extracting a face image or a range of the extraction.

As described above, by performing the process shown in FIG. 11 using the imaging device 1, the inquiry information is transmitted from the imaging device 1 to the inquiry device 50 sequentially and automatically. In other words, the face characteristic data Fa and Fb for a plurality of persons whose images are automatically picked up during policeman's patrol is sequentially transmitted to the inquiry device 50, and the image is recorded.

6. Processing Inquiry of Inquiry Device

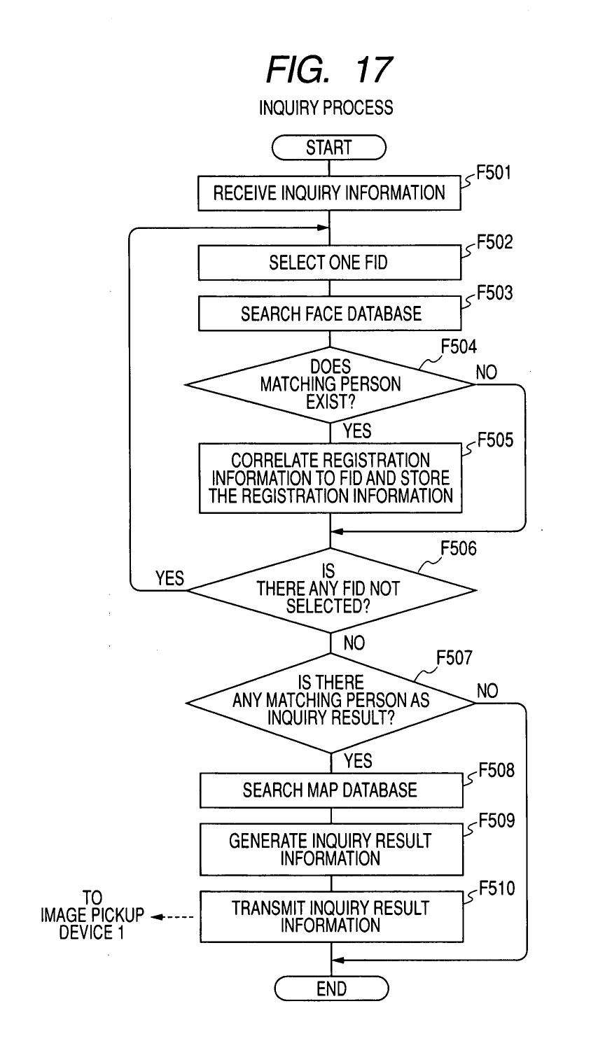

As described above, while the imaging device 1 sequentially transmits the inquiry information to the inquiry device 50, the inquiry device 50 performs to process the inquiry shown in FIG. 17 in response to the reception of the inquiry information.

In a step F501, the communication unit 103 receives inquiry information, and the reception data processing unit 51 inputs the inquiry information. When the inquiry information described with reference to FIG. 14 is input, the reception data processing unit 51 transmits/receives the FID and face characteristic data Fa and Fb which are included in the inquiry information to/from the inquiry processing unit 54.

The inquiry processing unit 54 performs the processes of steps F502 to F506 on one or more FIDs and face characteristic data Fa and Fb.

At first, in the step F502, one FID is selected. In the step F503, a searching process of the face database 57 is performed using face characteristic data Fa and Fb corresponding to the selected FID. In the face database 57, as shown in FIG. 8A, face characteristic data Fa and Fb for each registered person is recorded, and the searching process is to search for a person (registration number) whose face characteristic data Fa and Fb is completely identical to the face characteristic data Fa and Fb corresponding to the selected FID.

When a person registered in the face database 57 who has face characteristic data Fa and Fb identical to the face characteristic data Fa and Fb corresponding to the FID exists, the process is moved from the step F504 to the step F505, and the registration information registered in the face database 57 corresponding to the person (registration number), that is, personal information such as a registration type, name, and additional information is read, and the read registration information is stored in relation with the FID. Then, the process is moved to the step F506.

When a matching person is not found as the result of the search, the process of the step F505 is not performed, and the process is moved to the step F506.

In the step F506, it is determined whether there is any FID for which a search is not processed exists, and when there is any FID for which a search is not processed, the process is moved back to the step F502. Then, one of the FID for which a search is not processed is selected, and the same search process is performed in the step F503.

When the search processes for all the FIDs (face characteristic data Fa and Fb corresponding to FIDs) included in the received inquiry information are completed, the process proceeds from the step F506 to the step F507. When any matched person is not found for all the FIDs as the search result, the inquiry process is ended after the step F507.

On the other hand, when there is a matched person for at least one FID and the registration information is maintained in the step F505 corresponding to one or more FIDs, the process is moved to a step F508.

In the received inquiry information, as shown in FIG. 14, position information is included. The position information is transmitted to/from the transmission data generating unit 55. The transmission data generating unit 55 searches the map database 58 based on the latitude and longitude information of the position information in the step F508 and acquires detailed information (detailed position information) for the position information. The detailed position information, for example, may be map image data including a spot corresponding to the latitude and the longitude or text data describing the location corresponding to the latitude and the longitude. For example, the detailed position information may be text data such as “in front of xxx department store which is located in front of xxx station” and “xxx park located at 3 chome, xxx cho”.

The detailed position information enables the imaging device 1 to easily acquire the location where the image has been picked up for the inquiry information currently in processing.

Next, the transmission data generating section 42 generates inquiry result information using the detailed position information and the search result stored in the step F505 in a step F509.

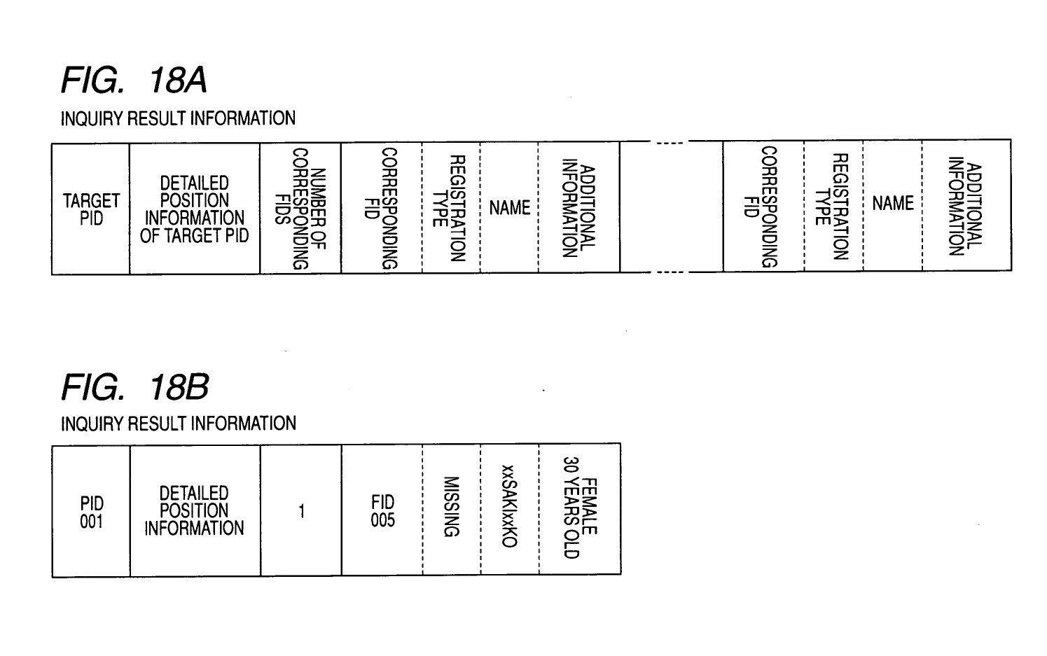

The inquiry result information, for example, is packet data having the contents shown in FIG. 18A.

At first, a target PID, that is, a PID which is included in the currently processed inquiry information is included in the packet data.

In addition, the detailed position information which is acquired from referring to the map database 58 is included in the packet data.

In addition, as a search result, the number of FIDs for which registered persons exist is represented, and as the search result, an FID for which a registered person exists and the contents of the registration (personal information such as a registration type and name) are repeatedly included.

A detailed example of the inquiry result information is shown in FIG. 18B.

As an example, it is assumed that inquiry information which is generated based on the picked-up image data PID001 shown in FIGS. 12A and 13A is transmitted from the imaging device 1.

In addition, it is assumed that the inquiry device 50 has processed up to the step F506 shown in FIG. 17 for searching the face database 57 based on face characteristic data Fa and Fb of each one of face images FID001 to FID005 and that only a person of the face image FID005 is registered in the face database 57 as a person whose face characteristic data Fa and Fb is identical to the one of the face images FID001 to FID005 as the search result.

In this case, in the step F505, the contents registered in the face database 57 correspondingly to the face image FID005 are maintained. For example, “a missing person” as a registration type and “xxsakixxko”, “female”, “30 years old”, and the like as personal information are read from the face database 57.

In the inquiry result information for this case, as shown in FIG. 18B, identification information corresponding to the picked-up image to be processed is included as a PID PID001, at first.

In addition, detailed position information is added. Then, one is added as the number of FIDs for which registered persons exist, and an FID FID005 for which a registered person exists and the contents of the registration of “a missing person, xxsakixxko, female, 30 years old” as the search result are added following the number of FIDs.

After the above-described inquiry result information is generated in a step F509, the transmission data generating unit 55 transmits the inquiry result information from the communication unit 103 to the imaging device 1 in a step F510.

The inquiry device 50 performs the above-described process shown in FIG. 17 whenever inquiry information is received from the imaging device 1.

Accordingly, when a person among the persons whose images are picked up by the imaging device 1 is registered in the face database 57, the inquiry result information as the inquiry result is transmitted from the inquiry device 50 to the imaging device 1.

7. Process of Imaging Device When Inquiry Result Information is Received

The process performed by the imaging device 1 at a time when the inquiry result information is transmitted from the inquiry device 50 is shown in FIG. 19.

In a step F601, the communication section 34 receives the inquiry result information from the inquiry device 50, and the reception data processing section 43 inputs the inquiry result information.

When the inquiry result information is received by the communication section 34 and the controller 40 receives the inquiry result information from the reception data processing section 43 in the step F601, the controller 40 directs the record and reproduction processing section 33 to read an image file from the memory card 5 based on a PID (target PID of FIG. 18A) included in the inquiry result information in a step F602.

In the memory card 5, an image file FL is recorded as shown in FIG. 15, and a target image file FL can be specified by the PID to be read. In other words, original image data corresponding to the received inquiry result information is read. For example, when the inquiry result information as shown in FIG. 18B is received, an image file FL including the picked-up image data shown in FIG. 12A is read based on the PID “PID001”.

Next, the controller 40 determines a target person in the read image data in a step F603. The determination is performed using an FID included in the inquiry result information and the FID related information in the read image file FL.

For example, in the inquiry result information shown in 18B, “FID005” is recorded as the corresponding person. In addition, in the read image file FL, FID related information as shown in FIG. 16B is included. By referring to the FID related information, it can be determined that the image of a person corresponding to “FID005” is positioned in a region within a circle which has a center coordinate C5 in the xy coordinate of the image data and a radius r5.

Next, the controller 40 acquires the latitude and longitude information as current position information from the position detection section 36 and calculates a relative position between a location at which the image data of the target PID “PID001” is picked up and the current location in the step F604. The relative position is information on which direction and how far the imaging location is located from the current location. The relative position can be calculated by comparing the current latitude and longitude to the latitude and longitude included in the detailed position information of the inquiry result information. When the imaging position information (latitude and longitude) is included in the attribute information for being recorded in recording the image file FL, the latitude and longitude may be compared to the current latitude and longitude.

In a step F605, the controller 40 transmits/receives information acquired from the contents of the received inquiry result information or information acquired from the processes of the steps F602, F603, and F604 based on the received inquiry result information to/from the display data generating section 44 to generate display data.

In other words, display data is generated using the detailed position information, personal information, and registration type information which are included in the inquiry result information, image data read from the memory card 5, information on the range of a face image of a target person in the image, relative position information, and the like.

In a step F606, the controller 40 notifies a user (policeman) of the imaging device 1 of the reception of the inquiry result information from the inquiry device 50. The notification is for urging the user to check the inquiry result in display section 11. For example, by outputting a reception notification sound from the voice output section 14 or vibrating a vibrator as the non-voice notification section 35, the reception notification may be performed.

At this time, the controller 40 may select the notification mode in accordance with the registration type included in the inquiry result information.

For example, a notified person as the inquiry result may be a missing person or a wanted person. There is a case where the policeman wearing the imaging device 1 is in the almost same location as the location at which the imaging regarding inquiry result information is performed when the inquiry result information is received. Especially when the process of the inquiry device 50 is performed quickly, a corresponding person may be located close to the policeman when the inquiry result information is received.

Considering these cases, it is predicted that the reception notification using a voice may be in appropriate for a person such as a wanted person who is highly suspected to run away.

Accordingly, for example, it is preferable that the controller 40 performs a reception notifying operation to a non-voice notification section 35 when a person such as a wanted person who is suspected to run away based on the registration type included in the inquiry result information is included and that the controller 40 directs to output a reception sound from the voice output section 14 in other cases.

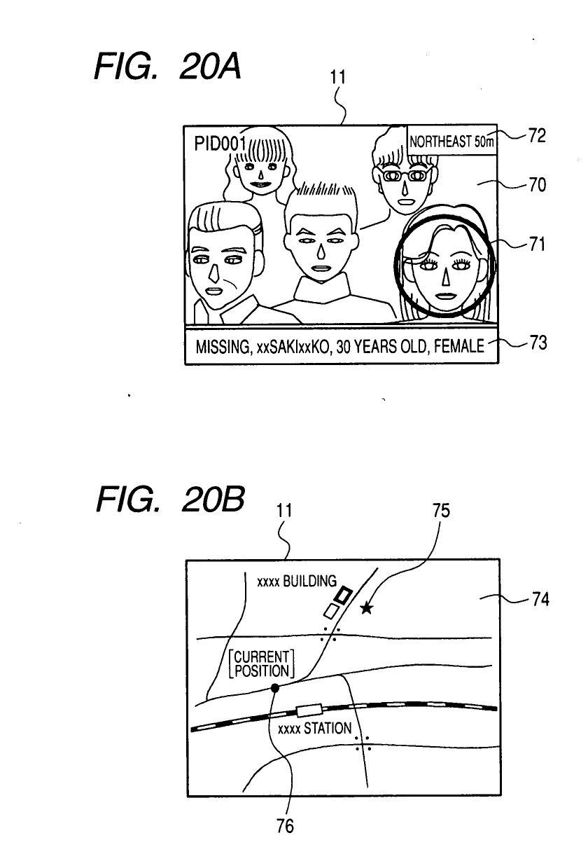

In a step F607, the display data generated based on the inquiry result information in the step F605 is displayed in the display section 11 to present the inquiry result to the policeman as a user. An exemplary display is shown in FIGS. 20A and 20B.

In FIG. 20A, an image display 70 of a photo image of the PID “PID001” which is read from the memory card 5, a target person display 71 in which a specific person is indicated by a circle in the image display, a relative position display 72 such as “North-East 50 m” as the relative position calculated in the step F604, and an inquiry content display 73 such as “a missing person, xxsakixxko, female, 30 years old” as information included in the inquiry result information are represented as an example. Of course, when text data representing an imaging location is included in detailed position information, the text data may be displayed additionally.

In FIG. 20B, when a map image is included in the detailed position information of the inquiry result information, a map image display 74, a target person imaging position which indicates a location at which the image of the target person is picked up in the map image, and a current position display 76 are represented as an example.

The display mode between the photo image shown in FIG. 20A and the map image shown FIG. 20B may be switched in accordance with a user's operation.

Of course, when the display area of the display section 11 is large enough to simultaneously display the photo image and the map image, the display contents of FIGS. 20A and 20B may be displayed together in one screen.

In addition, when a plurality of persons in one image are found as search targets and the inquiry result information is received, personal information for the persons may be simultaneously displayed or the target person display 71 and the inquiry content display 73 may be switched for each of the persons.

By checking the display, a policeman can determine a search target person whom the policeman comes across in patrol. In addition, the policeman can be in the vicinity of the search target person at the checking time. Accordingly, by checking the display content and searching the pertinent person, the policeman can instantly take a proper action such as protecting a missing person or arresting a wanted person.

8. Advantage of Embodiments and Modified Example

As described above, in an inquiry system according to an embodiment of the invention, for example, a policeman or the like wears an imaging device 1 in patrol or the like, and the imaging device 1 picks up an image, for example, at each predetermined time interval. When a face of a person is included in the picked-up image data, face characteristic data Fa and Fb is generated from the face image, and inquiry information including the face characteristic data is transmitted to an inquiry device 50.

When the inquiry information is received, the inquiry device 50 searches a face database 57 using the face characteristic data Fa and Fb included in the inquiry information. Then, the inquiry device 50 generates inquiry result information including the found personal information and transmits the inquiry result information to the imaging device 1. By receiving the inquiry result information, the imaging device 1 displays contents of the inquiry result such as personal information, a face image, and position information, as an example shown in FIGS. 20A and 20B, to the policeman or the like who wears the imaging device 1.

Accordingly, even when the policeman or the like does not have a clear memory of a face of a target person, does not have a picture with him, has difficulty in determining a target person, is unaware of searching for a person, or does not notice the target person, the policeman or the like can acquire information on the searching target person who is in the vicinity in patrol or the like.

Accordingly, the policeman or the like, as described above, can instantly take a proper action such as protecting a missing person or arresting a wanted person.

In addition, the burden on the policeman can be reduced, since the policeman does not have to have a clear memory of a face of a searching target person, does not take a picture with him during patrol, and does not have to concentrate only on searching for a missing person or a wanted person. During patrol, the policeman tends to takes various actions such as observation of street appearance for maintaining security, guidance of a person, and help as well as searching a person, and the policeman can search a person efficiently while taking the above-described actions.

In a system operation according to an embodiment of the invention, the transmission data between the imaging device 1 and the inquiry device 50 does not include image data itself. In other words, data size of the inquiry information or the inquiry result information as transmission data can be made much smaller than a case where image data is transmitted. Accordingly, the communication load can be small even when the transmission capacity of a network 90 is low, so that the communication can be made in a short time.

In addition, since the inquiry device 50 performs an automatic search based on the face characteristic data Fa and Fb, the process of an inquiry can be performed quickly and correctly. The process of an inquiry can be performed in a markedly short time compared to a case where a person searches a target person using his eyes by comparing to a picture or the like.

The fact that the transmission time or the inquiry processing time is short means that a time difference between when an image is picked up by the imaging device 1 and when the policeman acquires personal information on a searching target person as the result of the imaging is short. In other words, the policeman can acquire information on the searching target person when he is in vicinity of the searching target person. This is advantageous for the policeman's proper action.

According to an embodiment of the invention, the inquiry of a person is not performed by a person as in a case where a person compares pictures or a person determines the identity depending on his memory.

Moreover, the information on the relative positions of the face components such as eyes, a nose, and a mouth which becomes face characteristic data used for processing an inquiry is unique to each person and is not influenced by an appearance change according to an attachment such as a hair style or glasses. In addition, the information on the relative positions does not change with age.

Accordingly, the result of the inquiry of a target person can be highly accurate. Of course, a problem in an image quality, a difficulty in determination according to a changed request, and the like do not occur which occur in a case where a face image itself is transmitted to be compared.

In the inquiry device 50, personal information or a registration type is included in the inquiry result information, and the registration information or personal information included in the inquiry result information is displayed in the imaging device 1. For example, the personal information includes a name, age, sex, and the registration information includes a missing person.

The personal information is appropriate when a policeman searches for a target person or asks an on-duty question onsite. In addition, since the registration type such as a missing person, a wanted person, or a reference is displayed, the policeman can take a proper action when he finds the person.

As a detailed example of the registration type, when the registration type is classified by the crime into a brutal criminal, a larcenist, an incorrigible thief, and the like to be displayed, the registration type can be more useful for the policeman's reaction.

In the imaging device 1, the picked-up image data for which inquiry information is transmitted is recorded together with a PID in a memory card 5 by a record and reproduction processing section 33. The PID is included in the inquiry information and the inquiry result information.

Accordingly, when the imaging device 1 receives the inquiry result information, image data including the target person can be read from the memory card 5 by using the PID, and accordingly, the display as shown in FIG. 20A can be processed.

A person in an image can be specified by using an FID, and accordingly, an image can be displayed with a searching target person indicated as shown in FIG. 20A.

Accordingly, the policeman can check a place, a neighbor person, or the like which can be supposed from the face or appearance of the target person or a background at a time the image has been picked up, and thus the image display can be a very useful information.

The display of relative position information or detailed position information using a map image or text data enables the policeman to estimate the imaging location from the current location or to predict the action of the searching target person, and accordingly, the display can be useful information for taking a proper action.

In reception notification of the inquiry result information, as described above, a voice mode or a vibration mode can be switched in accordance with the registration type, so that the notification can be made with a neighbor target person considered.

The imaging device 1 according to an embodiment of the invention, as described with reference to FIG. 10, can transmit the registration information to the face database 57, and accordingly, the policeman can register a missing person or the like instantly, so that a search using the system can be processed thereafter.

The configurations and processes according to the above-described embodiments of the invention are examples, and any modified example according to an embodiment of the invention may be used.

In the above-described embodiment, an operation based on communication between an imaging device 1 and an inquiry device 50 is described, but the imaging devices 1 may be worn by a plurality of policemen or the like, respectively, for the same communication. Here, when the inquiry device 50 has found a searching target person in response to the inquiry information transmitted from an imaging device 1, the inquiry device 50, for example, may not only transmit the inquiry result information to the imaging device 1 which has transmitted the inquiry information as described above, but also transmit the inquiry result information or a support request to the imaging devices 1 of neighbor policemen, for example, imaging devices 1 of a plurality of policemen responsible for a corresponding area or the imaging device 1 of another policeman located in vicinity of the corresponding location.

For example, since the inquiry information including position information is sequentially transmitted from the imaging device 1, the inquiry device 50 can acquire the current locations of the policemen wearing the imaging devices 1. Accordingly, it is possible to transmit the inquiry result information or a support request to a policeman who is currently located in vicinity of a corresponding location.

The registration of a person in the face database 57 can be performed by transmitting the registration information from the imaging device 1 in the above-described embodiment, but the registration can be performed, for example, by recording the registration information generated by the imaging device 1 in the memory card 5 and providing/receiving the memory card 5 to/from the inquiry device 50 for reading the registration information. Alternatively, the registration information generated by the imaging device 1 may be transmitted to another information processing device such as a personal computer of a police branch office using the memory card 5 or the external interface 37, and the registration information may be transmitted to the inquiry device 50 through network communication from the personal computer or the like.

In the face database 57, the picked-up image data itself may be registered. Moreover, the image data picked up by the imaging device 1 may be transmitted/received to/from the inquiry device 50 by providing/receiving the memory card 5, communication using a personal computer or the like, or communication from the imaging device 1 so as to register the picked-up image data in the face database 57.

As an example, there is a case where the target person cannot be found even when a policeman in patrol receives the inquiry result information. In this case, a corresponding image file recorded in the imaging device 1 (memory card 5) is provided/received to/from the inquiry device 50 for being registered in the face database 57. In the image file, the appearance or condition of the searching target person at the time of imaging remains as a pickup image. In addition, there is information in the image file that the target person was at a specific location at the time of imaging. Since the above-described information is helpful for a search thereafter, it is useful to register the image file recorded by the imaging device 1 in the face database 57.

The transmission interval of the inquiry information from the imaging device 1, that is, the performing interval of the process shown in FIG. 11 may be configured to be able to be set arbitrary or switched to be changeable by an operation. In addition, a shock sensor, a voice sensor, or the like may be prepared to detect an emergent situation, and the transmission interval may be shortened when an emergency occurs.

In addition, the transmission interval may be set differently by the area, and when the imaging device 1 is in a crowded location, a bad security area, or the like, the interval of imaging and the transmission of inquiry information may be configured to be automatically shortened.

In the example of the process in the inquiry device 50 shown in FIG. 17, when there is no matched person as the result of search, the inquiry result information is not transmitted and the process is ended. This process is preferable, since the reduction of communication load, for example, as an inquiry system in which the inquiry information is sequentially transmitted from a plurality of imaging devices 1 or the reduction of additional transmission process of the inquiry device 50 can be achieved.

Alternatively, as another example of the process, even when there is not a matched person, the notification for the search result may be transmitted to the imaging device 1. In addition, when the notification of no matched person is received, the imaging device 1 may remove the image file (image file of the corresponding PID) stored in the memory card 5 to increase the available storage amount of the memory card 5.

In the above-described embodiment, the inquiry system is described as a system used for security or police, but the inquiry system may be used for any other purpose.

For example, the inquiry system may be used for searching for a missing child in a public facility, an amusement park, and the like.

The program according to an embodiment of the invention may be implemented as a program allowing the controller 40 of the imaging device 1 to perform the transmission process of the inquiry information shown in FIG. 11 and the reception process of the inquiry result information shown in FIG. 19. In addition, the program according to an embodiment of the invention may be a program allowing the CPU 101 of the inquiry device 50 to perform the inquiry process shown in FIG. 17.

The program may be recorded in advance in a system HDD as a recording medium of an information processing device such as a computer system or a ROM of a micro computer having a CPU.

Alternatively, the program may be stored (recorded) temporarily or permanently in a removable recording medium such as a flexible disk, a CD-ROM (Compact Disc Read Only Memory), an MO (Magnet optical) disk, a DVD (Digital Versatile Disc), a magnetic disk, and a semiconductor memory. The removable recording medium may be provided as so-called package software. For example, by being provided in a CD-ROM, a DVD-ROM, or the like, the program can be installed in a computer system.

The program may be downloaded from a download site through a network such as a LAN (Local Area Network), the Internet, or the like other than being installed from a removable recording medium.

It should be understood by those skilled in the art that various modifications, combinations, sub-combinations and alterations may occur depending on design requirements and other factors insofar as they are within the scope of the appended claims or the equivalents thereof.

What is claimed is:

1. An inquiry system comprising:
a portable imaging device; and
an inquiry device capable of communicating with the imaging device in two ways,
wherein the imaging device includes
an imaging unit picking up image data,
a communication unit communicating with the inquiry device,
a face characteristic data generator extracting a face image from the image data picked up by the imaging unit and generating face characteristic data from the extracted face image,
a transmission information generator generating inquiry information including the face characteristic data and transmitting the inquiry information to the inquiry device by using the communication unit, and
a presentation processor performing a presentation process based on inquiry result information in response to reception of the inquiry result information transmitted from the inquiry device by using the communication unit, and
wherein the inquiry device includes
a communication unit communicating with the imaging device,
a face database in which personal information is registered together with the face characteristic data,
an inquiry processor searching the face database using the face characteristic data included in the inquiry information in response to reception of the inquiry information transmitted from the imaging device by using the communication unit, and
a transmission information generator generating the inquiry result information including the personal information found in the face database by the inquiry processor and transmitting the inquiry result information to the imaging device by using the communication unit.

2. An imaging device which is formed to be portable and is capable of communicating with an inquiry device in two ways, the imaging device comprising:
an imaging unit picking up image data;
a communication unit communicating with the inquiry device;
a face characteristic data generator extracting a face image from the image data picked up by the imaging unit and generating face characteristic data from the extracted face image;
a transmission information generator generating inquiry information including the face characteristic data and transmitting the inquiry information to the inquiry device by using the communication unit; and
a presentation processor performing a presentation process based on inquiry result information in response to the reception of the inquiry result information transmitted from the inquiry device by using the communication unit.

3. The imaging device according to claim 2, wherein the face characteristic data is relative position information of face components.

4. The imaging device according to claim 2, wherein the transmission information generator generates the inquiry information including image identification information assigned to the image data from which the face image is extracted by the face characteristic data generator.

5. The imaging device according to claim 2, wherein the transmission information generator generates the inquiry information including face identification information assigned to the face image that is extracted from the image data by the face characteristic data generator, with the face identification information related with the face characteristic data.

6. The imaging device according to claim 2, further comprising a position detector detecting position information, and
wherein the transmission information generator generates the inquiry information including the position information as a location of picking up the image data which is detected by the position detector.

7. The imaging device according to claim 2, further comprising a personal information inputting unit inputting personal information,
wherein the transmission information generator generates registration information including the face characteristic data which is generated by the face characteristic data generator and the personal information which is input by the personal information inputting unit and transmits the generated registration information to the inquiry device by using the communication unit.

8. The imaging device according to claim 2, further comprising a recording and reproducing unit performing record and reproduction for a recording medium,
wherein the recording and reproducing unit records the image data from which the face image is extracted by the face characteristic data generator in the recording medium.

9. The imaging device according to claim 8, wherein the recording and reproducing unit records the image data from which the face image is extracted by the face characteristic data generator together with image identification information assigned to the image data in the recording medium.

10. The imaging device according to claim 9, wherein the recording and reproducing unit records the image data from which the face image is extracted by the face characteristic data generator together with face identification information related information that relates face identification information assigned to the face image included in the image data with a position of the face image in the image data in the recording medium.

11. The imaging device according to claim 2, wherein the presentation processor performs a presentation process of personal information included in the inquiry result information.

12. The imaging device according to claim 9, wherein the presentation processor performs a presentation process of image data which is read from the recording medium by the recording and reproducing unit based on the image identification information included in the inquiry result information.

13. The imaging device according to claim 10, wherein the presentation processor performs a presentation process of the image data in a status that a target face image is indicated in the image data which is read from the recording medium by the recording and reproducing unit based on the face identification information and the face identification information related information which are included in the inquiry result information.

14. The imaging device according to claim 2, wherein the presentation processor performs a presentation process of position information included in the inquiry result information.

15. The imaging device according to claim 2, further comprising a position detector detecting position information,
wherein the presentation processor generates relative position information indicating a position represented by position information included in the inquiry result information from the current position information detected by the position detector and performs a presentation process of the relative position information.

16. The imaging device according to claim 2, further comprising a reception notifying unit notifying that the communication unit has received the inquiry result information,
wherein the reception notifying unit selects a notification mode based on registration type information included in the inquiry result information to notify the reception of the inquiry result information.

17. An inquiry device capable of communicating with an imaging device in two ways, the inquiry device comprising:
a communication unit communicating with the imaging device;
a face database in which personal information is registered together with face characteristic data;
an inquiry processor searching the face database using the face characteristic data included in the inquiry information in response to reception of the inquiry information transmitted from the imaging device by using the communication unit, and
a transmission information generator generating the inquiry result information including the personal information found in the face database by the inquiry processor and transmitting the inquiry result information to the imaging device by using the communication unit.

18. The inquiry device according to claim 17, wherein the face characteristic data is relative position information of face components.

19. The inquiry device according to claim 17, wherein the transmission information generator generates the inquiry result information including image identification information included in the inquiry information.

20. The inquiry device according to claim 17, wherein the transmission information generator generates the inquiry result information in which the personal information found by the inquiry processor is related with face identification information included in the received inquiry information.

21. The inquiry device according to claim 17, further comprising a map database in which map information is stored,
wherein the transmission information generator searches the map database using position information included in the received inquiry information and generates position information as text data or image data based on the result of the search to generate the inquiry result information including the generated position information.

22. The inquiry device according to claim 17, wherein registration type information is recorded together with the personal information and the face characteristic data in the registration database, and
wherein the transmission information generator generates the inquiry result information including the registration type information.

23. The inquiry device according to claim 17, further comprising a registration processor relating the face characteristic data and the personal information which are included in the registration information in response to the reception of the registration information including the face characteristic data and the personal information and registering the face characteristic data and the personal information in the face database.

24. A method of processing information using an imaging device which is formed to be portable and is capable of communicating with an inquiry device in two ways, the method comprising the steps of:
picking up image data;
extracting a face image from image data which is picked up by the pick-up of image data and generating face characteristic data from the extracted face image;
generating inquiry information including the face characteristic data and transmitting the inquiry information to the inquiry device; and
performing a presentation process based on the inquiry result information in response to the reception of the inquiry result information transmitted from the inquiry device.

25. A method of processing information using an inquiry device capable of communicating with an imaging device in two ways, the method comprising the steps of:
searching a face database in which personal information is registered together with face characteristic data using the face characteristic data included in the inquiry information in response to the reception of the inquiry information transmitted from the imaging device and
generating the inquiry result information including the personal information found in the face database by the searching the face database and transmitting the inquiry result information to the imaging device.

26. A program for operating an imaging device which is formed to be portable and is capable of communicating with an inquiry device in two ways, the program implementing in the imaging device the steps of:
picking up image data;
extracting a face image from image data which is picked up by the picking up an image and generating face characteristic data from the extracted face image;
generating inquiry information including the face characteristic data and transmitting the inquiry information to the inquiry device; and
performing a presentation process based on inquiry result information in response to the reception of the inquiry result information transmitted from the inquiry device.

27. A program for operating an inquiry device capable of communicating with an imaging device in two ways, the program implementing in the inquiry device the steps of:
searching a face database in which personal information is registered together with face characteristic data using the face characteristic data included in inquiry information in response to the reception of the inquiry information transmitted from the imaging device; and
generating inquiry result information including the personal information found in the face database by the searching the face database and transmitting the inquiry result information to the imaging device.
